(19) United States
(12) Patent Application Publication
(10) Pub. No.: US 2013/0018701 A1
(43) Pub. Date: Jan. 17, 2013

(54) CAPTURING AND PROCESSING DATA RESPONSIVE TO A TASK ASSOCIATED WITH CONSUMER RESEARCH, SURVEY, OR POLL

(71) Applicants: Matthew Dusig, Pacific Palisades, CA (US); Gregg Lavin, Thousand Oaks, CA (US); Steven Sobolevsky, Tarzana, CA (US); Allen Vartazarian, Encino, CA (US)

(72) Inventors: Matthew Dusig, Pacific Palisades, CA (US); Gregg Lavin, Thousand Oaks, CA (US); Steven Sobolevsky, Tarzana, CA (US); Allen Vartazarian, Encino, CA (US)

(21) Appl. No.: 13/535,204

(22) Filed: Jun. 27, 2012

Related U.S. Application Data
(63) Continuation-in-part of application No. 13/211,720, filed on Aug. 17, 2011.
(60) Provisional application No. 61/476,802, filed on Apr. 19, 2011.
(60) Provisional application No. 61/476,803, filed on Apr. 19, 2011.
(60) Provisional application No. 61/374,609, filed on Aug. 17, 2010.

(51) Int. Cl. G06Q 30/02

(52) U.S. Cl. 705/7.32; 705/14.19

(57) ABSTRACT

A method may include receiving, at a mobile computing device from a server via a network, survey information, where the survey information may include data capture instructions. The method may further include presenting, on a display of the mobile computing device, the data capture instructions and a control for capturing data, where the control for capturing data may be configured upon selection to activate a peripheral feature of the mobile computing device, and where the peripheral feature may be configured to capture one or more of audio content, image content, and video content. The method may further include receiving selection of the control for capturing data, and activating the peripheral feature. The method may further include intercepting capture data, where the capture data was created by the peripheral feature. The method may further include providing, to the server via the network, capture information associated with the capture data.

### RELATED APPLICATIONS

This patent application is a continuation in part of, and claims priority to, U.S. application Ser. No. 13/211,720, entitled “Selecting and Processing Offers to Complete Tasks, Research Programs, and Consumer Rewards Programs based on Location,” and filed Aug. 17, 2011, which is hereby incorporated by reference in its entirety. U.S. application Ser. No. 13/211,720 claims priority to (a) U.S. Application No. 61/374,609, entitled “Location Based Market Research and Rewards Program,” filed Aug. 17, 2010; (b) U.S. Application No. 61/476,802, entitled “Location Based Market Research Program,” filed Apr. 19, 2011; and (c) U.S. Application No. 61/476,803, entitled “Location Based Consumer Rewards Program,” filed Apr. 19, 2011, each of which are hereby incorporated by reference in their entirety.

This patent application is related to U.S. application Ser. No. 13/211,708, filed Aug. 17, 2011, and U.S. application Ser. No. 13/211,714, filed Aug. 17, 2011, each of which are hereby incorporated by reference in their entirety.

### BACKGROUND OF THE DISCLOSURE

Obtaining information about a vendor's enterprises may be useful for a vendor. Obtaining information about members of a consumer base may be useful for a vendor. Mobile computing devices such as smart phones often include hardware and software components enabling a user to capture rich media files and/or optical machine-readable data.

### SUMMARY

In one aspect, the present disclosure describes a method that may include receiving, at a mobile computing device from a server via a network, survey information, where the survey information may include data capture instructions. The method may further include presenting, by a processor of the mobile computing device, on a display of the mobile computing device, the data capture instructions and a control for capturing data, where the control for capturing data may be configured upon selection to activate a peripheral feature of the mobile computing device, and where the peripheral feature may be configured to capture one or more of audio content, image content, and video content. The method may further include receiving selection of the control for capturing data, and activating, by the processor, the peripheral feature. The method may further include intercepting, by the processor, capture data, where the capture data was created by the peripheral feature. The method may further include providing, to the server via the network, capture information associated with the capture data.

The capture information may include a rich media file. The method may further include receiving, from the server, responsive to the capture information, verification information. The method may further include presenting, by the processor, on the display, the verification information and a control, where the control is configured upon selection to cause an indication of approval to be provided to the server. The verification information may include a network address for reviewing a portion of the capture information. The peripheral feature may include a camera, where the peripheral feature may be configured to capture image content. The capture information may include an image file, and the portion of the capture information may include a scaled version of the image file.

The peripheral feature may include an optical scanner, where the peripheral feature is configured to capture image content. The portion of the capture information may include meta data regarding a product.

Providing the capture information may include providing a command to an upload interface of the server. The server may include two or more networked servers.

Presenting the data capture instructions may include presenting the data capture instructions within a browser application executing upon the mobile computing device. The method may further include receiving, from the server, responsive to the capture information, rejection information, where the rejection information is provided responsive to a determination that the capture information is insufficient. The method may further include, responsive to receiving the rejection information, causing presentation, by the processor, on the display, data recapture instructions and the control for capturing data.

In one aspect, the present disclosure describes a system that may include a processor and memory storing instructions thereon, where the instructions when executed may cause the processor to receive, at a mobile computing device from a server via a network, survey information, where the survey information may include data capture instructions. The instructions when executed may further cause the processor to present, on a display, the data capture instructions and a control for capturing data, where the control for capturing data may be configured upon selection to activate a peripheral feature of the mobile computing device, and where the peripheral feature may be configured to capture one or more of audio content, image content, and video content. The instructions when executed may further cause the processor to receive selection of the control for capturing data, and activate the peripheral feature. The instructions when executed may further cause the processor to intercept capture data, where the capture data was created by the peripheral feature. The instructions when executed may further cause the processor to provide, to the server via the network, capture information associated with the capture data.

In one aspect, the present disclosure describes a non-transient computer readable medium having instructions stored thereon that, when executed, may cause a processor to receive, at a mobile computing device from a server via a network, survey information, where the survey information may include data capture instructions. The instructions when executed may further cause the processor to present, on a display, the data capture instructions and a control for capturing data, where the control for capturing data may be configured upon selection to activate a peripheral feature of the mobile computing device, and where the peripheral feature may be configured to capture one or more of audio content, image content, and video content. The instructions when executed may further cause the processor to receive selection of the control for capturing data, and activate the peripheral feature. The instructions when executed may further cause the processor to intercept capture data, where the capture data was created by the peripheral feature. The instructions when executed may further cause the processor to provide, to the server via the network, capture information associated with the capture data.

In one aspect, the present disclosure describes a method that may include determining, by a processor of a computing device, an offer including at least one task. The method may further include providing, for presentation on a mobile computing device, offer information, where the offer information may include identification of the offer. The method may further include receiving, from the mobile computing device, a selection identifying the offer. The method may further include determining, by the processor that the mobile computing device includes a peripheral feature configured to capture a rich media file type, where a first task of the at least one task may include capturing the rich media file type. The method may further include providing, for presentation on the mobile computing device, a request for information related to the first offer, where the request may include a request for a user to perform the first task. The method may further include receiving, from the mobile computing device, information related to an outcome of performance of the first task, where the information related to the outcome of performance of the first task may include capture information derived from capture of the rich media file type, and the information related to the outcome of performance of the task may be indicative of a completion of the task by the user. The method may further include determining, by the processor, acceptability of the capture information. The method may further include providing, by the processor, to the mobile computing device, preview information configured to present a preview version of a portion of the capture information to the user.

Determining the offer may include determining the offer responsive to determining that the mobile computing device includes the peripheral feature configured to capture the rich media file type. Determining acceptability of the capture information may include validating content of the capture information in relation to the first task.

The first task may include a location, the capture information may include geolocation information, and validating content of the capture information may include determining the geolocation information is within a threshold distance of the location.

The first task may include recording an audio message, the capture information may include an audio file, and validating content of the capture information may include determining the audio file meets a threshold recording length.

The first task may include scanning a bar code, the capture information may include a product identification code, and validating content of the capture information may include determining one or more predetermined product identification codes includes the product identification code.

The method may further include storing, by the processor, the capture information in a memory. The method may further include, prior to storing the capture information, modifying, by the processor, the capture information. The capture information may be modified to a standardized file format.

The method may further include receiving, from the mobile computing device, an indication of rejection of the preview information. The method may further include, responsive to the indication of rejection, providing, to the mobile computing device, recapture information.

In one aspect, the present disclosure describes a system that may include a processor and memory storing instructions thereon, where the instructions when executed may cause the processor to determine an offer including at least one task. The instructions when executed may further cause the processor to provide, for presentation on a mobile computing device, offer information, where the offer information may include identification of the offer. The instructions when executed may further cause the processor to receive, from the mobile computing device, a selection identifying the offer. The instructions when executed may further cause the processor to determine that the mobile computing device includes a peripheral feature configured to capture a rich media file type, where a first task of the at least one task may include capturing the rich media file type. The instructions when executed may further cause the processor to provide, for presentation on the mobile computing device, a request for information related to the first offer, where the request may include a request for a user to perform the first task. The instructions when executed may further cause the processor to receive, from the mobile computing device, information related to an outcome of performance of the first task, where the information related to the outcome of performance of the first task may include capture information derived from capture of the rich media file type, and the information related to the outcome of performance of the task may be indicative of a completion of the task by the user. The instructions when executed may further cause the processor to determine acceptability of the capture information. The instructions when executed may further cause the processor to provide, to the mobile computing device, preview information configured to present a preview version of a portion of the capture information to the user.

In one aspect, the present disclosure describes a non-transient computer readable medium having instructions stored thereon that, when executed, may cause a processor to determine an offer including at least one task. The instructions when executed may further cause the processor to provide, for presentation on a mobile computing device, offer information, where the offer information may include identification of the offer. The instructions when executed may further cause the processor to receive, from the mobile computing device, a selection identifying the offer. The instructions when executed may further cause the processor to determine that the mobile computing device includes a peripheral feature configured to capture a rich media file type, where a first task of the at least one task may include capturing the rich media file type. The instructions when executed may further cause the processor to provide, for presentation on the mobile computing device, a request for information related to the first offer, where the request may include a request for a user to perform the first task. The instructions when executed may further cause the processor to receive, from the mobile computing device, information related to an outcome of performance of the first task, where the information related to the outcome of performance of the first task may include capture information derived from capture of the rich media file type, and the information related to the outcome of performance of the task may be indicative of a completion of the task by the user. The instructions when executed may further cause the processor to determine acceptability of the capture information. The instructions when executed may further cause the processor to provide, to the mobile computing device, preview information configured to present a preview version of a portion of the capture information to the user.

### BRIEF DESCRIPTION OF THE DRAWINGS

The following figures depict certain illustrative implementations of the methods and systems described herein, where like reference numerals refer to like elements. Each depicted implementation is illustrative of the methods and systems and not limiting.

FIGS. 1 and 2 are block diagrams of exemplary computing devices usable in the systems of FIGS. 3, 10, and 20;

FIG. 3 is a block diagram of an exemplary system for selecting and processing offers to complete tasks;

FIGS. 4 and 5 are flow diagrams of exemplary methods for selecting and processing offers to complete tasks;

FIGS. 6-9 include exemplary user interfaces for selecting and processing offers to complete tasks;

FIG. 10 is a block diagram of an exemplary system for deploying a location based market research program and/or a location based rewards program;

FIG. 11 is a flow diagram of an exemplary method 1100 determining the location of a user of a mobile device;

FIG. 12 is a flow diagram of an exemplary method for identifying and transmitting market research surveys to a mobile device;

FIG. 13 is a flow diagram of an exemplary method for identifying consumer rewards programs located near a mobile device;

FIG. 14 is a flow diagram of an exemplary method for selecting and processing a research program;

FIG. 15 is a flow diagram of an exemplary method for selecting and processing a research program;

FIG. 16 is a flow diagram of an exemplary method for determining a research program and compensation for a user;

FIG. 17 is a flow diagram of an exemplary method for determining research programs and compensation for a user;

FIGS. 18 and 19 include exemplary user interfaces for selecting and processing research programs and compensation;

FIG. 20 is a diagram of an exemplary system for providing and processing survey questions by capturing data through a mobile computing device peripheral feature;

FIGS. 21A through 21D include exemplary user interfaces for answering a survey question by capturing data using a mobile computing device peripheral feature;

FIG. 22 is a swim diagram of an exemplary method for providing and processing survey questions including a rich media response format;

FIG. 23 is a flow diagram of an exemplary method for providing and processing survey questions including a rich media response format;

FIG. 24 is a flow diagram of an exemplary method for receiving and responding to survey questions including a rich media response format;

FIG. 25 is a flow diagram of an exemplary method for receiving and responding to survey questions including an optical machine-readable data response format;

FIG. 26 is a block diagram of an example network environment usable in the systems of FIGS. 3, 10, and 20.

### DETAILED DESCRIPTION

The methods, systems and apparatus described herein are not limited to the specific devices, methods, applications, conditions or parameters described and/or shown herein. It is to be appreciated that certain features of the methods, systems and structures described herein are described in the context of separate implementations, and may be provided in any combination or sub-combination of the implementations described herein. Furthermore, any reference to values stated in ranges includes each and every value within that range.

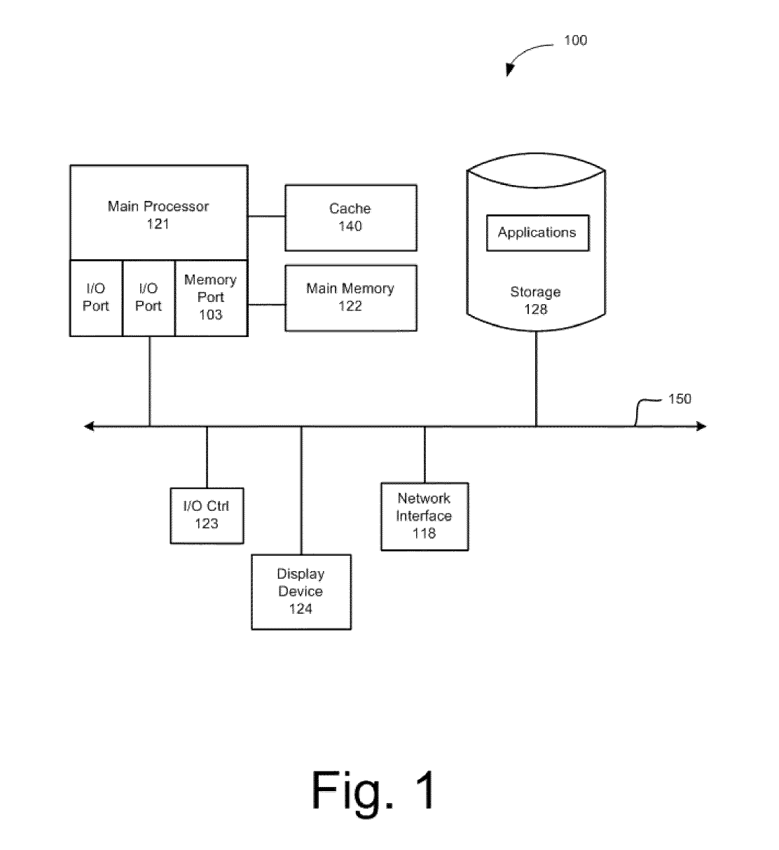

Illustrated in FIG. 1 is one implementation of a computing device 100 such as any computing device described herein. Computing device 100 can include a central communication bus 150 that communicates with each of the components included in the computing device 100. These components can include: an input/output (I/O) control 123; a display device 124; a network interface 118; a storage repository 128; a main processor 121; cache 140; and memory 122. The main processor 121 can include elements such as one or more I/O ports, or a memory port 103.

Further referring to FIG. 1, and in more detail, in some implementations the computing device 100 can be any computing device 100 having a processor 121. The computing device 100 can be a mobile device such as a laptop, netbook, smart phone, electronic reader, cell phone, personal digital assistant, tablet computer or any other hand-held computing device comprising a processor 121. In some implementations, the computing device 100 can be any hand-held mobile device able to carry out the methods and systems described herein. In some implementations, the computing device 100 can be a computer, a client computer, a server, or any other machine comprising a processor 121 able to execute computer readable instructions. The computing device 100, in some implementations, can be referred to as a computer, a computing machine, a machine, a device, a mobile device, or a mobile device.

The processor 121 included in the computing device 100 can be referred to as a central processing unit (CPU) or as a main processor. In some implementations, the processor 121 can include a single processing core, while in some implementations the processor 121 can include multiple processing cores. When the processor 121 includes multiple processing cores, the cores can execute in parallel and can access a shared memory location or individual memory locations assigned to particular cores. In some implementations, the computing device 100 can include multiple processors 121. When the processor 121 includes multiple processing cores or multiple processors, the processors can execute a single instruction simultaneously on multiple pieces of data (SIMD), or in some implementations can execute multiple instructions simultaneously on multiple pieces of data (MIMD).

In one implementation, the processor(s) 121 can be any processor. In some implementations, the processor(s) 121 can be any combination of a microprocessor, a microcontroller, programmable logic gates, or any other processor. The processor 121, in some implementations, can further comprise a graphics processing unit (GPU) which can include any combination of hardware and processor-executable instructions for processing graphics data and graphics commands. In some implementations, the processor 121 can further comprise a graphics engine or any other processing engine.

I/O ports can be included on the processor(s) 121 and can be used to interface with I/O controllers 123 and I/O devices. These I/O devices can include display devices 124, keyboards, mice, pointers, printers, microphones, other computing machines, speakers, or any other I/O device. In some implementations the I/O devices can communicate with the computing device 100 via the I/O controller 123, while in some implementations the I/O controller 123 can be used to communicate and control the I/O device. The I/O device, in some implementations, can function as a communication bus that establishes communication between an external device or computer and the computing device 100. For example, the I/O device can be any of the following buses: a USB bus; an Apple Desktop Bus; an RS-232 serial connection; a SCSI bus; a FireWire bus; a FireWire 800 bus; an Ethernet bus; an AppleTalk bus; a Gigabit Ethernet bus; an Asynchronous Transfer Mode bus; a HIPPI bus; a Super HIPPI bus; a SerialPlus bus; a SCI/LAMP bus; a FibreChannel bus; or a Serial Attached small computer system interface bus. In another implementation, the I/O device can be an external storage unit such as flash memory or a hard drive. When the I/O device is a display device 124, the display device 124 can be any display device including an integrated display or an external monitor or other similar display device.

The processor 121 can interface with any number of memory elements or storage repositories. In some implementations the processor 121 can interface with cache memory 140 which can be any cache memory 140 and in some implementations can be static random access memory (SRAM), dynamic random access memory (DRAM), enhanced DRAM, or any other type of memory. Similarly the main memory unit 122 can be any type of memory. The processor 121 can interface and interact with the main memory 122 and any other memory unit via a system bus 150, a memory port 103 or any other connection. The processor can further access any storage repository 128 or additional memory location. In some implementations, the processor 121 can access any application or data stored in the storage repository 128. The processor 121, in some implementations, accesses a stored application to execute that application.

The computing device 100, in some implementations, can execute an operating system. In some implementations, the operating system can be any operating system, while in some implementations the operating system can be any embedded operating system for a mobile device. In some implementations, the computing device 100 can execute multiple operating systems.

A network interface 118 can be included in the computing device 100 and can be used to interface with any network. In some implementations, the network interface 118 can communicate over a local area network (LAN), a wide area network (WAN), a wireless network, or any other network. The network interface 118, in some implementations, can be a built-in network adapter; a network interface card; a PCMCIA network card; a card bus network adapter; a wireless network adapter; a USB network adapter; a modem; or any other device suitable for interfacing the computing device 100 to a network.

The systems, software, and methods described herein can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object oriented programming language, or in assembly or machine language if desired. In any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files, such devices include magnetic disks, such as internal hard disks and removable disks magneto-optical disks and optical disks. Storage devices suitable for tangibly embodying computer program instructions and data include all forms of non-volatile memory, including, by way of example, semiconductor memory devices, such as EPROM, EEPROM, and flash memory devices; magnetic disks such as, internal hard disks and removable disks; magneto-optical disks; and CD_ROM disks. Any of the foregoing can be supplemented by, or incorporated in, ASICs (application-specific integrated circuits).

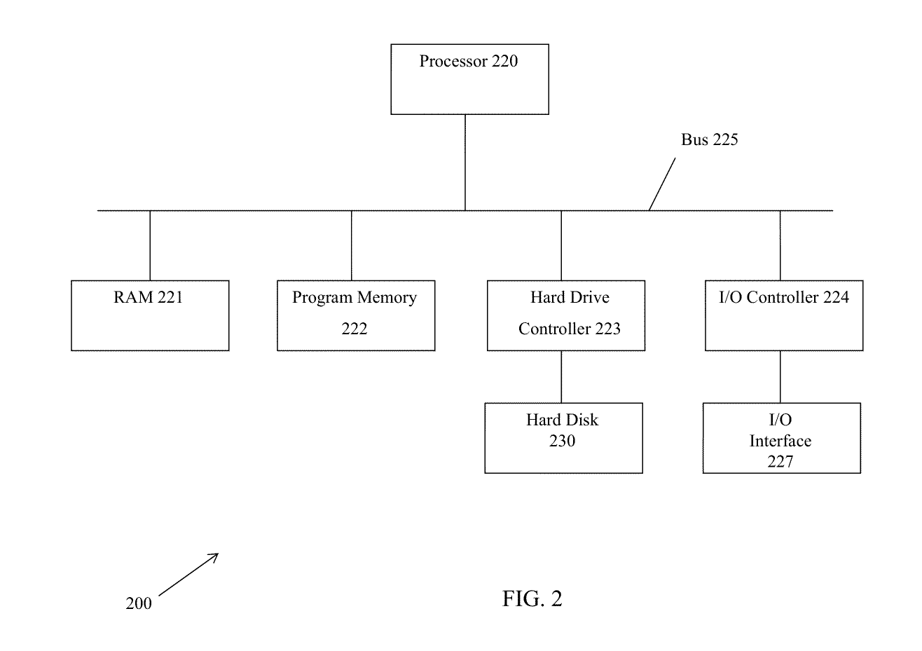

An example of one such type of computer is shown in FIG. 2, which shows a block diagram of a programmable processing system (system) 211 suitable for implementing or performing the apparatus or methods described herein. The system 211 includes a processor 220, a random access memory (RAM) 221, a program memory 222 (for example, a writeable read-only memory (ROM) such as a flash ROM), a hard drive controller 223, and an input/output (I/O) controller 224 coupled by a processor (CPU) bus 225. The system 211 can be preprogrammed, in ROM, for example, or it can be programmed (and reprogrammed) by loading a program from another source (for example, from a floppy disk, a CD-ROM, or another computer).

The hard drive controller 223 is coupled to a hard disk 230 suitable for storing executable computer programs, including programs embodying the present methods, and data including storage. The I/O controller 224 is coupled by an I/O bus 226 to an I/O interface 227. The I/O interface 227 receives and transmits data in analog or digital form over communication links such as a serial link, local area network, wireless link, and parallel link.

Elements of different implementations described herein may be combined to form some implementations not specifically set forth above. Some implementations not specifically described herein are also within the scope of the claims.

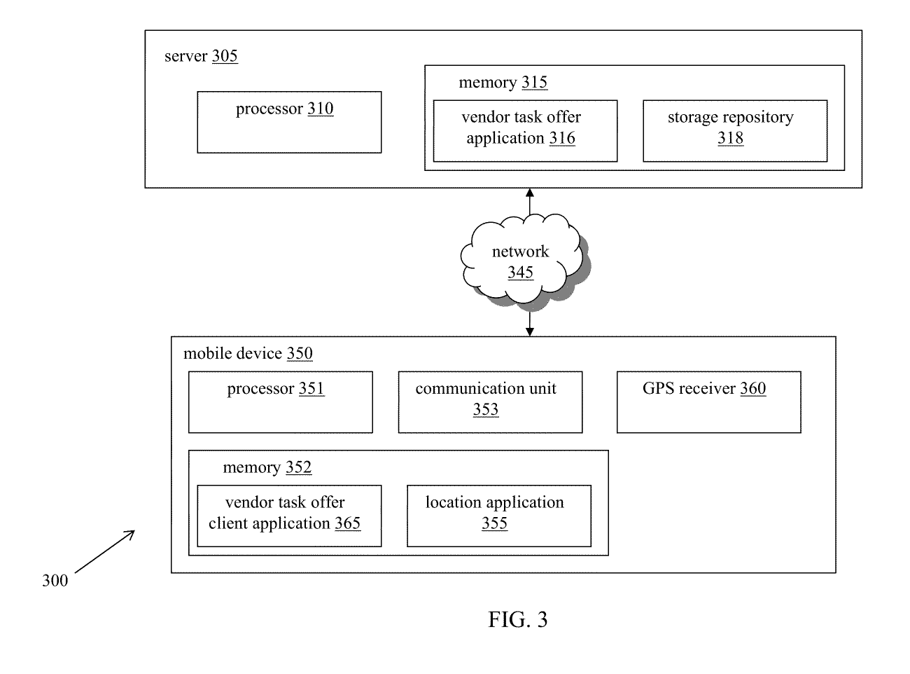

Referring now to FIG. 3, a system 300 for selecting and processing offers to complete tasks is shown and described. The system 300 includes a server 305 in communication over a network 345 with a mobile device 350. The server 305 may include a processor 310. The server 305 may include a memory 315. In some implementations, the memory 315 may store instructions for execution. For example, the memory 315 may store instructions for a vendor task offer application 316. In some implementations, the memory 315 may include a storage repository 318. For example, the memory may store offers to complete tasks (also referred to herein as “task offers”). Each offer may be associated with a third party, such as a vendor.

The mobile device 350 may include a processor 351 and a memory 352. The memory 352 may include instructions that, when executed by the processor 351, cause the mobile device 350 to operate according to any of the functions described herein. For example, the memory may include instructions for a vendor task offer client application 365. The mobile device 350 may include a communication unit 353. In some implementations, the communication unit 353 may communicate with cellular networks and/or computer networks. In some implementations, the mobile device 350 may include a location application 355. In some implementations, the mobile device 350 may include a Global Positioning System (GPS) receiver 360.

The memory 352 of the mobile device 350 may include a vendor task client application 365. In some implementations, mobile device 350 may include an application in which selecting and processing task offers may be a function and/or subapplication. In some implementations, a user may obtain the vendor task client application 365 from a website (e.g., download the application). In some implementations, the user may obtain the vendor task client application 365 at a centralized location for marketing mobile device 350 applications. Purchasing and/or requesting the vendor task client application 365 may initiate a download from the centralized location to the mobile device 350.

In operation, a user of the mobile device 350 may request a display of at least one offer to complete one or more tasks. In some implementations, the user may make the request by opening the vendor task client application 365 on the device 350. For example, the user may open the application 365 by selecting an icon on the device's 350 touchscreen. In another example, the user may open the application 365 by accessing the application 365 via a menu and/or control panel. The application 365 may require the user to enter credentials (e.g., username, password). In some implementations, the user may make the request by accessing a function of an open application. The user may navigate through an open application's menu to access the function that requests offers to complete tasks. The user may select a tab for an open application to access the function.

In response to the user's request, the mobile device 350 may determine the device's location. In some implementations, a location application 355 and/or a GPS receiver 360 may determine the location based on messages from GPS satellites. The GPS receiver 360 may receive the messages. The messages may include at least the time the signal was transmitted and/or orbital information about the satellite(s). The location application 355 may use the information in the messages to determine distances to each of the satellites. The location application 355 may use the distances and the satellites' locations to determine the device's 350 location. In some implementations, the location application 355 may use triangulation to determine the location.

In some implementations, the location application 355 may use telecommunication signals to determine the device's 350 location. The location application 355 may use messages from cellular networks to determine the location. In some implementations, the location application 355 may connect to any data networks meeting the International Mobile Telecommunications-2000 (IMT-2000) standards (e.g., 3G, 4G). The location application 355 may use any information from signals transmitted via the networks to determine the device's 350 location.

In some implementations, the location application 355 may use signals from computer networks to determine the device's 350 location. For example, the location application 355 may connect to a computer network using IEEE 802.11 standards. The location application 355 may connect to a computer network using any standards covered by the Wi-Fi™ standards. The application 355 may use any information from signals transmitted via the computer networks to determine the device's 350 location.

In some implementations, the location may include coordinates. The coordinates may correspond to the device's 350 position on the surface of the earth. The coordinates may include Cartesian coordinates. The location may include coordinates for latitude and longitude. In some implementations, the location may include an address corresponding to the coordinates for the location.

The mobile device 350 may send the location to the server 305. In some implementations, the mobile device 350 may send the username of the user of the device 350. In some implementations, the mobile device 350 may send an identifier of the device 350 (e.g., device serial number). The mobile device 350 may send the version number of the vendor task client application 365. In some implementations, the mobile device 350 may send the model and/or version of the device 350 (e.g., iPhone 4 manufactured by Apple Inc. of Cupertino, Calif.; Droid 3 manufactured by Motorola, Inc. of Schaumberg, Ill.). The mobile device 350 may send any of the information described herein to the vendor task offer application 316 on the server 305. In some implementations, the device 350 may send the information via Representational State Transfer (REST) requests. The device 350 may send the information using Hypertext Transfer Protocol (HTTP).

The server 305 may identify a user based on the username and/or identifier of the device 350. The server 305 may associate the location and the user. In some implementations, the server 305 may retrieve a user profile associated with the user from the storage repository 318. The user profile may include any information about the user. For example, the user profile may include the user's gender, age, income level, city of residence, or any other demographic information. In some implementations, the user profile may include a radius (e.g., a maximum distance between the user and vendors' enterprises for which task offers should be displayed to the user).

In some implementations, the vendor task offer application 316 may identify at least one vendor task offer based on the location of the mobile device 350 and/or the user profile. The application 316 may identify vendors with at least one enterprise (e.g., retail store, franchise) within a threshold distance of the device 350. In some implementations, the application 316 may query the storage repository 318 for task offers associated with vendors with an enterprise within the threshold distance. For example, suppose the threshold distance is 50 feet. The application 316 may determine that Coffee Company A has a coffee store 25 feet from the user. The application 316 may identify the task offer associated with Coffee Company A as a task offer to potentially send to the user. In another example, the application 316 may determine that Bakery B has a franchise within 10 feet of the user. The application 316 may identify the task offer associated with Bakery B as a task offer to potentially send to the user. In another example, the application 316 may determine that Clothing Company C has a retail store within 100 feet of the user. Since the distance is larger than the threshold distance of 50 feet, the application 316 may not identify the task offers associated with the clothing company.

Although the threshold distance used in these examples is 50 feet, other values may be used. In some implementations, threshold distances may be determined based on information in the user profile (e.g., a user setting indicating how far a user may be willing to travel for a task offer). In some implementations, the vendor task offer application 316 may select the threshold distances. For example, the application 316 may include a default threshold distance.

In some implementations, the application 316 may use a threshold distance selected by a vendor. Different vendors may select different threshold distances. For example, the application 316 may determine that Clothing Company D has a retail store within 75 feet of the user. Because Clothing Company D has selected a threshold distance of 100 feet, the application 365 may identify Clothing Company D as a vendor whose task offer may be delivered to the user. In another example, the application 316 may determine that Coffee Company B has a coffee shop within 80 feet of the user. However, because Coffee Company B has selected a threshold distance of 50 feet, the application 316 may not identify Coffee Company B as a vendor whose task offer may be delivered to the user.

In some implementations, the application 316 may identify task offers based on information in the user profile. The profile may include behavioral information about the user. For example, the profile may include a list of vendors for which the user is already a repeat customer. For example, the profile may indicate the user regularly drinks coffee from Coffee Company A, buys suits from Work Clothes Giant, purchases electronics from High Tech Fanatics stores, and eats at Mexican Burritos Unlimited. Using such information, the application 316 may rank task offers for these vendors with enterprises within the threshold distance of the user. The application 316 may rank the task offers according to the vendors from whom the user already makes purchases.

In some implementations, the application 316 may eliminate task offers from consideration according to the user profile. For example, if the profile indicates the user does not consume alcohol, the application 316 may not select task offers associated with retailers for alcoholic beverages. If the profile indicates the user has not yet reached a legal drinking age, the application 316 likewise may not select task offers associated with retailers for alcoholic beverages. In some implementations, the user profiles may indicate the categories of vendors for whom the user would be willing to perform tasks. In some example, the user profile may include task offers previously completed by the user. The user profile may indicate the user has already completed a task offer for Coffee Company A three times. Thus, the application 316 may eliminate task offers associated with Coffee Company A from consideration.

In some implementations, more than one task offer may be associated with a vendor. The application 316 may identify one of the task offers based on the user profile. For example, a vendor may have task offers with different sets of tasks for users with different demographic profiles. The vendor task offer application 316 may identify the vendor's task offer corresponding to the user's demographic profile.

In some implementations, the vendor task offer application 316 may obtain task offers for identified vendors with at least one enterprise within one or more threshold distances of the user. For example, the application 316 may retrieve the task offers from the storage repository 318. In some implementations, the task offer may include an amount of compensation for a user who completes the tasks in the offer. The amount of compensation may be an amount of cash, rewards points for a vendor and/or program, or any other compensation as would be appreciated by one of ordinary skill in the art. In some implementations, the amount of compensation may be a rebate and/or a coupon for a vendor.

The task offer may include a single amount of compensation. The task offer may include different amounts of compensation and conditions associated with each amount. Conditions may include requirements regarding demographic information (e.g., vendors may offer different amounts of compensation to encourage participation from members of demographics for which the vendors may have less information). For example, male users between the ages of 21-34 may be eligible for compensation of $A, whereas male users between the ages of 35-50 may be eligible for compensation of $B. In some implementations, amounts of compensation may vary based on gender, age, ethnicity, residency, income level, or any other factor.

In some implementations, the task offer may include at least one required capability for the user's mobile device 350. For example, if a task in a task offer involves capturing an image, the task offer may require the mobile device 350 to include a camera. In another example, if a task involves scanning a barcode, the task offer may require the mobile device 350 to include a scanner and/or a camera. In another example, if a task involves obtaining an audio file, the task offer may require the mobile device 350 to include a microphone. The application 316 may determine the device's 350 capabilities according to the model and/or version number of the device's 350. In some implementations, the application 316 may select task offers whose requirements may be met by the model and/or version number.

The vendor task offer application 316 may send descriptions of the task offers to the mobile device 305. Each description may include the name of the vendor, the address of the vendor's enterprise, and/or an amount of compensation for completing the tasks requested by the vendor. The vendor task offer client application 365 on the mobile device 305 may receive the descriptions. The mobile device 305 may display a list of the tasks. The user of the device 305 may scroll down the list, by way of example.

The user may select a task offer. In some implementations, the user may select the task offer by touching an area of the device's 350 touch screen associated with the task offer. The user may enter a symbol corresponding to the task offer (e.g., the number of the task in a list). The device 350 may send the selection to the vendor task offer application 316 on the server 305. In some implementations, upon the user selection of the task offer, the location application 355 may obtain the device's 350 location. The location application 355 may send the updated location to the server 305. The vendor task offer application 316 on the server 305 may determine the user remains within a threshold distance of the enterprise before sending the requests of the task offer to the mobile device 350.

In some implementations, the application 316 may obtain the first request for data of the task offer. The application 316 may process the first request for data for display on the mobile device 305. For example, the application 316 may create a user interface presenting the request for data. The application 316 may send the user interface to the mobile device 350 for display thereon.

Exemplary requests for data may include requests for the user to perform an act and provide information regarding the enterprise's response to the act. For example, the request may ask the user to enter a retail store and indicate how promptly a sales clerk offered assistance (e.g., measure the time that elapses, provide a “yes/no” response regarding the promptness). The request may ask the user to request service from a sales clerk in a retail store and describe the clerk's behavior. A request may ask the user to ask a grocery store employee for a location of an item and indicate if the employee's answer is accurate. A request may ask the user to order a cappuccino in a coffee shop and measure the time between order and delivery of the beverage. A request may ask the user a question regarding the cleanliness of visible work surfaces in a sandwich shop.

A request may ask the user to capture an image of himself or herself in front of the enterprise to verify the user is at the location. A request may ask the user to purchase an item and capture an image of the item. A request may ask the user to enter the enterprise's public bathroom and capture an image of the facilities. A request may ask the user to capture an image of the shelves at the retail outlet. A request may ask the user to capture an image of the window display at the retail outlet. A request may ask the user to order a drink and capture an image of the drink, the receipt, or the user holding the drink and/or receipt. A request may ask the user to scan a barcode for merchandise at a retail outlet. A request may ask the user to capture an image of the kitchen counter at a diner. The request may ask the user to request service from a sales clerk in a retail store and capture an audio file of the clerk's response.

The user may answer a question in the request, upload a captured image and/or audio file, scan a barcode, or prepare any other data in the request. In some implementations, the user interface may include an input field through which the user may indicate that data cannot be obtained (e.g., a request asks for an image of the restaurant's bathroom, but the facilities have been unavailable for 15 minutes). Through the interface, the user may explain why data cannot be obtained.

In some implementations, the vendor task client application 365 measures a period of time that elapses between display of the request in the user interface and the user's completed preparation of the data. In some implementations, the application 365 may append a time and/or date of capture to an image or audio file. In some implementations, the location application 355 may determine the mobile device's 350 location at the time of capture. The device 350 may append the data with the location (e.g., geo-tag and/or geo-code the data).

The mobile device 350 may submit the data to the vendor task offer application 316 on the server 305. The vendor task offer application 316 may determine the acceptability of the data. The application 316 may determine if the period of time that elapsed between display of the request in the user interface and the user's preparation of the data exceeds a threshold. If the period of time does not, the application 316 may determine the data is unacceptable. Thus, the application 316 may contemplate situations in which the user has provided a cursory and/or unserious response to the data (e.g., a user is nominally performing tasks to obtain the compensation). The application 316 may determine the credibility of a user indication that data cannot be obtained (e.g., the user has waited 30 seconds for the restaurant's bathroom to become available, but the user has claimed to have waited 15 minutes).

In some implementations, the vendor task offer application 316 may determine the quality of the data. For example, the application 316 may determine whether an image file, an audio file, and/or a file with a scanned barcode are uncorrupted. In some examples, the application 316 may analyze the quality of the data. The application 316 may determine if a captured image is in focus. The application 316 may determine if a captured image is sufficiently bright so as to see the image's subjects. The application 316 may determine if a captured image includes the subjects of the request (e.g., whether the user simply took a picture of the floor). The application 316 may determine if a captured audio file includes static. The application 316 may determine if a length of the audio file matches the length included in the request for data.

In some implementations, the vendor task offer application 316 may determine if the user's location when preparing the data is within a threshold distance of the enterprise. For example, the user may have purportedly captured an image of a retail store's window display. However, if the location in the image's geo-tag indicates the user was 150 feet away from the retail store during image capture, the application 316 may determine the image is unreliable.

In some implementations, the vendor task offer application 316 may notify the mobile device 350 that the data is unacceptable. The application 316 may send the device 350 a notification for display. In some implementations, the vendor task offer client application 365 on the mobile device may process the notification. The client application 365 may display a request for a resubmission of data. In some implementations, the application 365 may not request a resubmission of data. In some implementations, if data is unacceptable because the user is providing nominal data, the vendor task offer application 316 may determine the user is an uncredible source of data and terminate the task offer.

The vendor task offer application 316 may obtain the next request for data of the task offer. The application 316 may create a user interface presenting the next request and send the user interface to the mobile device 350. The user may obtain and submit the data to the vendor task offer client application 356, according to any of the steps described herein. The applications 316, 365 may perform any of the steps described herein for each request for data in the task offer.

The vendor task offer application 316 may determine whether the amount of compensation should be allocated to the user. The application 316 may determine the compensation should be allocated when all the received data from the user is acceptable. The application 316 may determine the compensation should be allocated when a threshold number and/or percentage of user submitted data is acceptable. For example, if the user provided five acceptable responses to requests for data but a submitted audio file has some static, the application 316 may determine the user nevertheless submitted a satisfactory amount of data. In some implementations, the application 316 may determine compensation should not be allocated when the application 316 determines the user is uncredible (e.g., when the application 316 terminates the task offer prior to completion of all the tasks).

The application 316 may increase an account associated with the user by the amount of compensation. The application 316 may send a notification to the mobile device 350 indicating the amount of compensation for completing the task offer will be added to the user's account. In some implementations, the application 316 may include a lottery system. For example, the application 316 may randomly select users to receive bonus amounts of compensation. Thus, 1% of the users may receive twice the amount of compensation in the task offer.

In some implementations, the vendor task client application 365 may not display an amount of compensation. Compensation may be allocated according to a lottery and/or sweepstakes system. For example, one (1) out of every hundred (100) people who complete the task offer may receive a larger amount of compensation (e.g., $100), although other percentages and/or ratios may be used.

In some implementations, the vendor task offer application 316 may send all the user interfaces for all the requests for data in a task offer to the mobile device 350. The mobile device 350 may store and display the user interfaces to the user. The user may navigate through the user interfaces, and the mobile device 350 may store each data prepared by the user. Once the user has provided data for all the requests, the mobile device 350 may send all the data to the vendor task offer application 316 together. The application 316 may determine the acceptability of the data according to any of the steps described herein.

In some implementations, the mobile device 350 may store data from the user if the device 350 cannot communicate with the server 305 (e.g., insufficient signal strength from the cellular network, interruptions in service in a telecommunications network). The user may continue navigating through the user interfaces and preparing data. The mobile device 350 may determine that communication with the server 305 has resumed. The mobile device 350 may submit the stored data provided by the user to the vendor task offer application 316.

In some implementations, the vendor task offer application 316 may identify a task offer associated with a vendor with an enterprise that is not within a threshold distance of the device 350. The application 316 may notify the user that the task offers may become available once the user moves within the threshold distance to the enterprise.

In some implementations, the vendor task offer application 316 may establish a communication channel between the mobile device 350 and the vendor of the selected task offer. For example, the application 316 may establish an instant messaging session or video chat session between personnel for the vendor and the mobile device 350. The personnel may send the user requests for data in real-time. In some implementations, personnel may determine the acceptability of data from the user and/or request resubmission of data. The personnel may determine if the user is a credible source of data.

In some implementations, the vendor task client application 365 may be embedded in an application for a third-party. For example, a social media organization may embed the vendor task application into its own application for mobile devices. Thus, when the social media organization's application is open and/or active, the vendor task client application 365 receive task offers from the vendor task offer application 316 to present to the user. In some implementations, the compensation for completing task offers may be a form of currency usable on through social media organization. For example, the compensation may be virtual points usable at the organization's site.

In another example, a game application may embed the vendor task client application 365 into its own mobile device application. Compensation for completing task offers may be a form of currency applicable to the game. For example, if the game application requires a subscription, the compensation may be payment covering the subscription for a predetermined period of time (e.g., day, week, month). In some examples, compensation may be an item usable in the game (e.g., “lives” to continue playing the game, virtual currency to purchase items used in the game). Various organizations may embed the vendor task offer client application 365 into their own mobile applications, as would be appreciated by one of ordinary skill in the art.

In some implementations, the user may download a vendor task offer client application 365 without registering with the vendor task service. When the server 305 determines the user has submitted satisfactory data for a task offer, the vendor task offer client application 365 may require the user to register. The user may provide identification information and/or create credentials for the account. The vendor task application may apply the amount of compensation for completing the ask offer to the user's account.

In some implementations, while the vendor task offer client application 365 is active, the location application 355 may determine the device's 350 location on a periodic basis (e.g., once every 3 minutes, 10 minutes). The location application 355 may send the updated location to the vendor task offer application 316 on the server 305. The vendor task offer application 316 may determine task offers available within the threshold distance(s) of the updated location. The vendor task offer application 316 may send descriptions of the updated task offers to the mobile device 350 for display.

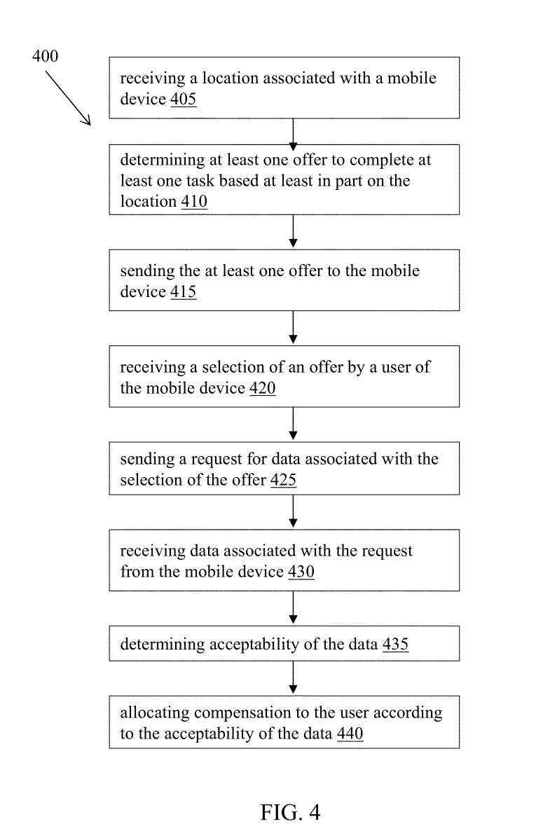

Referring now to FIG. 4, a flow diagram 400 of an exemplary method for selecting and processing offers to complete tasks is shown and described. The method may include receiving a location associated with a mobile device (step 405). A server 305 may receive the location. The location may include coordinates. The location may include an address. The server 305 may direct the location to a vendor task client application 365. In some implementations, the server 305 may receive an identity of a user with the location. The server 305 may receive a username of the user.

The method may include determining at least one offer to complete at least one task based at least in part on the location (step 410). In some implementations, a vendor task offer application 316 may query a storage repository 318 for task offers associated with vendors with at least one enterprise located within a threshold distance of the mobile device 350. The application 316 may determine a distance between the location associated with the mobile device and a location of an enterprise for a third party associated with the at least one offer. The application 316 may compare the distance with a threshold. If the threshold exceeds the distance, the application 316 may select the task offer as an offer to send to the user at the mobile device 350.

In some implementations, the vendor task offer application 316 may determine the at least one offer based at least in part on a profile of the user of the mobile device. The server 305 may retrieve the user profile for the storage repository 318. The server 305 may identify task offers based on behavioral information about the user. For example, the server 305 may identify task offers associated with vendors for whom the user is already a repeat customer. The server 305 may identify a task offer directed to users in the user's demographic group. The server 305 may identify a task offer based on user profile information according to any method described herein.

The method may include sending the at least one offer to the mobile device (step 415). The server 305 may create a user interface presenting descriptions of each task offer to send to the user. The description may include an identity of the vendor, an address for the vendor's enterprise, and/or an amount of compensation for completing the task offer.

The method may include receiving a selection of an offer by a user of the mobile device (step 420). The method may include sending a request for data associated with the selection of the offer (step 425). In some implementations, the request for data may include a request for information associated with a task. The server 305 may create a user interface including the request for data. The server 305 may create a user interface including a request for information associated with the task. The requests may be any of the requests described herein. The server 305 may send the user interface for display on the mobile device 350.

The method may include receiving data associated with the request from the mobile device (step 430). In some implementations, the data associated with the request may be an image, a video file, an audio file, and/or a response to a question. The data may be any of the data described herein. In some implementations, the data may include the time, date, and location where the data had been captured.

The method may include determining acceptability of the data (step 435). Acceptability of the data may be determined based on the quality of an image (e.g., focus, brightness, identification of desired subjects) or the quality of an audio file (e.g., volume, amount of static), by way of example. Acceptability of the data may be determined based on the distance between the enterprise associated with the vendor and the location where the data was captured and/or the location of a mobile device 350 when the data was sent. If the distance falls below a threshold, the vendor task offer application 316 may determine that the data is acceptable. In some implementations, acceptability may be determined based on the period of time that elapsed between display of the request for data on the mobile device and the capture of the data and/or sending of the data to the server 305.

In some implementations, the vendor task offer application 316 may determine a task has been completed if the data for the task is acceptable. The application 316 may compare a number of completed tasks and a number of uncompleted tasks. In some implementations, the application 316 may determine a percentage of completed tasks, for the total number of tasks in the task offer. In some implementations, a task offer may require a predetermined number of completed tasks or a predetermined percentage of completed tasks.

The method may include allocating compensation to the user according to the acceptability of the data (step 440). If the number of completed tasks equals or exceeds the predetermined number of completed tasks required by the task offer, the vendor task offer application 316 may determine the user should receive compensation for the task offer. If the percentage of completed tasks equals or exceeds the predetermined percentage required by the task offer, the application 316 may determine the user should receive compensation for the task offer. The application 316 may increase increasing an amount in an account associated with the user.

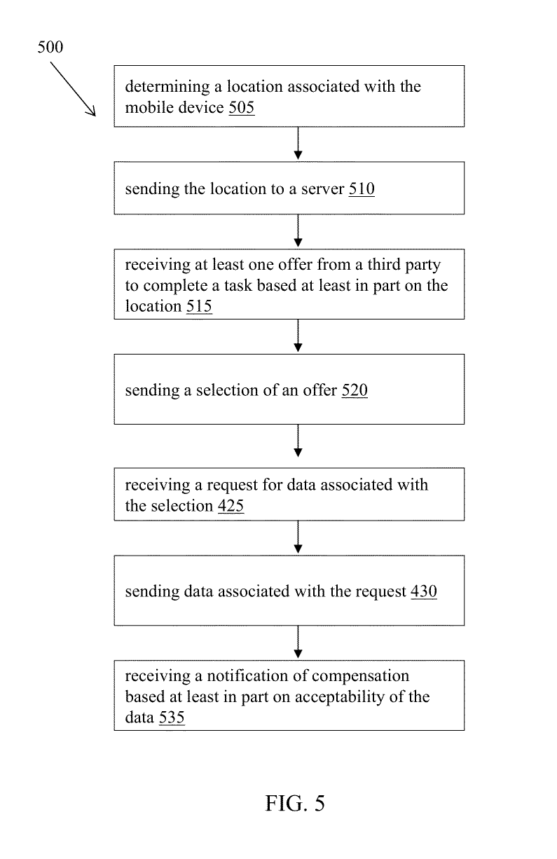

Referring now to FIG. 5, a flow diagram 500 of an exemplary method for selecting and processing offers to complete tasks is shown and described. The method may include determining a location associated with the mobile device (step 505). A mobile device 350 may determine its location in response to a user request for task offers. A location application 355 on the device 350 may determine the location based on signals received from GPS satellites. The location application 355 may triangulate the signals to determine the device's 350 location. The location application 355 may use signals from a computer network and/or a cellular network to determine the device's 350 location.

The method may include sending the location to a server (step 510). The mobile device 350 may also an identity of the user (e.g., username). The mobile device 350 may send a serial number of the device, from which a vendor task application on the server 305 may identify the user. The method may include receiving at least one offer from a third party to complete a task based at least in part on the location (step 515). The method may include sending a selection of an offer (step 520). The selection may be based on a user touching an area of the device's 350 touch screen corresponding to the offer. The selection may be based on the user inputting a symbol corresponding to the offer (e.g., the number of the offer in a list of task offers).

The method may include receiving a request for data associated with the selection (step 525). The request for data may be presented in a user interface and displayed on the mobile device's 350 display. The request for data may be any of the requests described herein. The method may include sending data associated with the request (step 530). The mobile device 350 may send to the server 305 any of the data described herein. The method may include receiving a notification of compensation based at least in part on acceptability of the data (step 535). The notification may include a message that an addition of the amount of compensation for the task offer to the user's account may be pending.

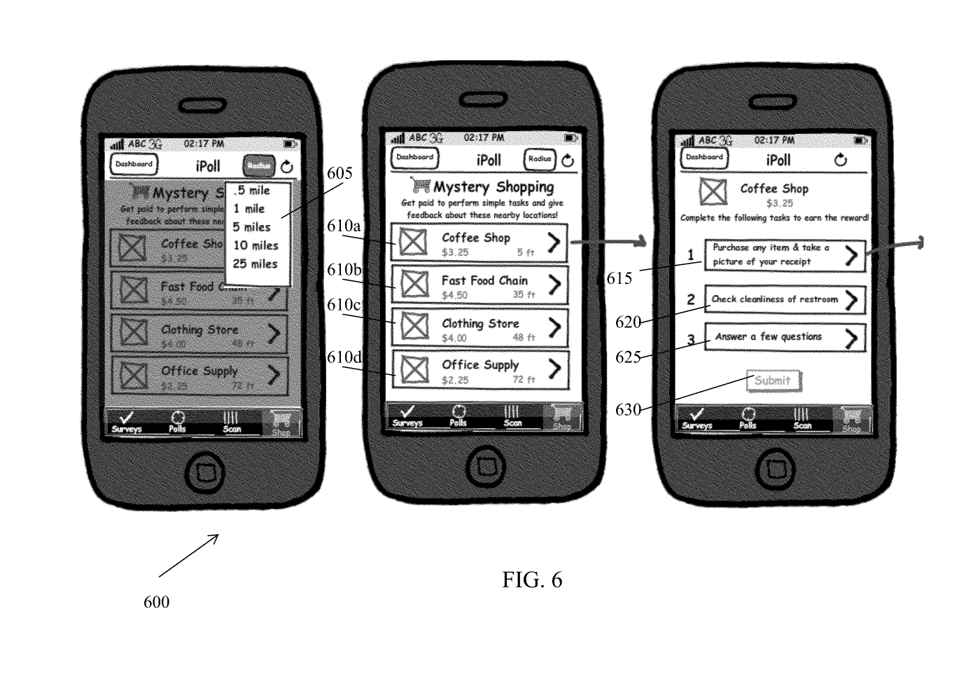

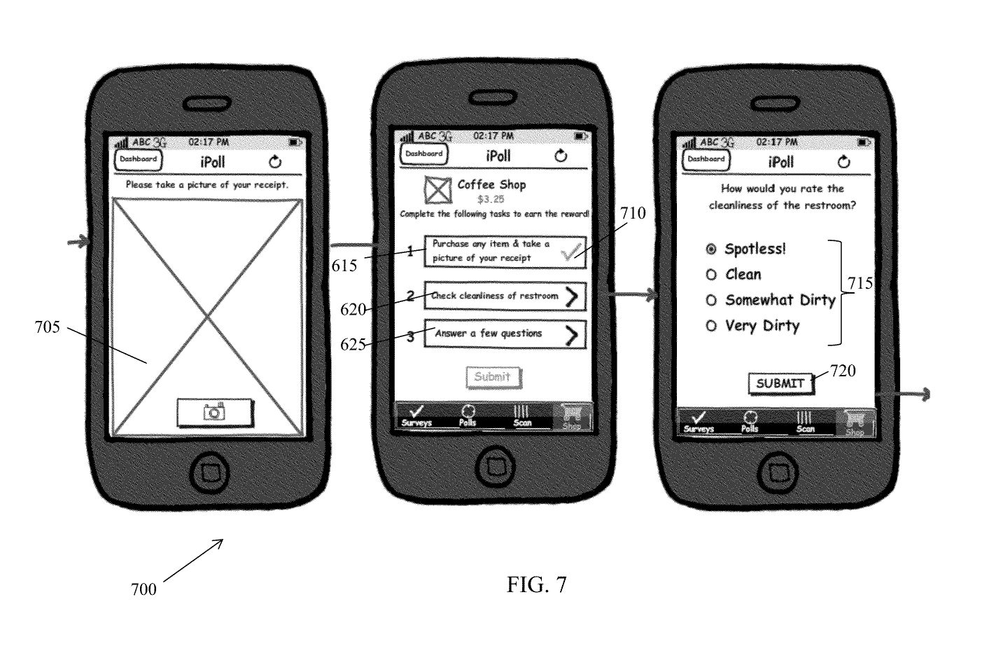

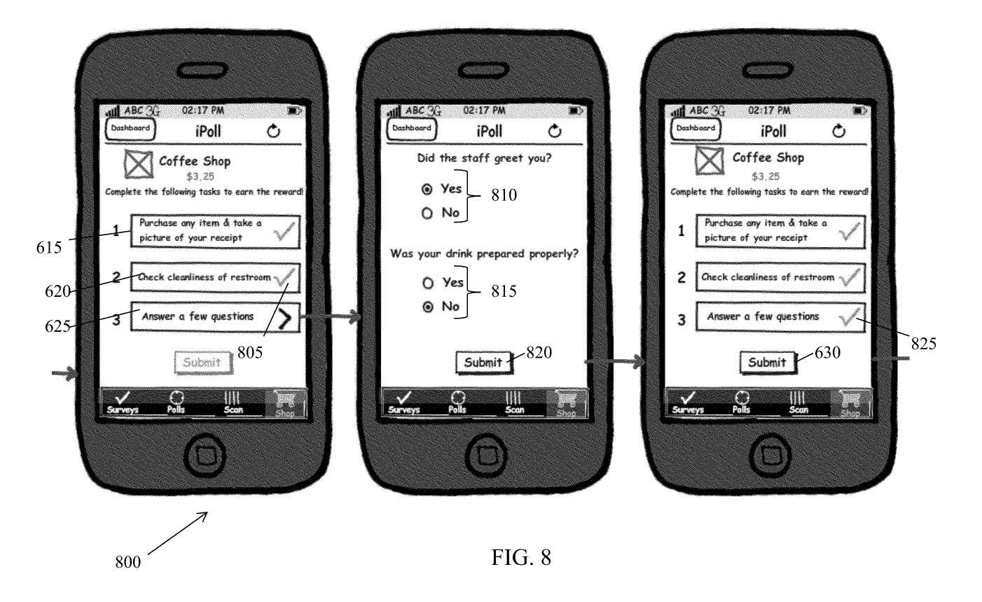

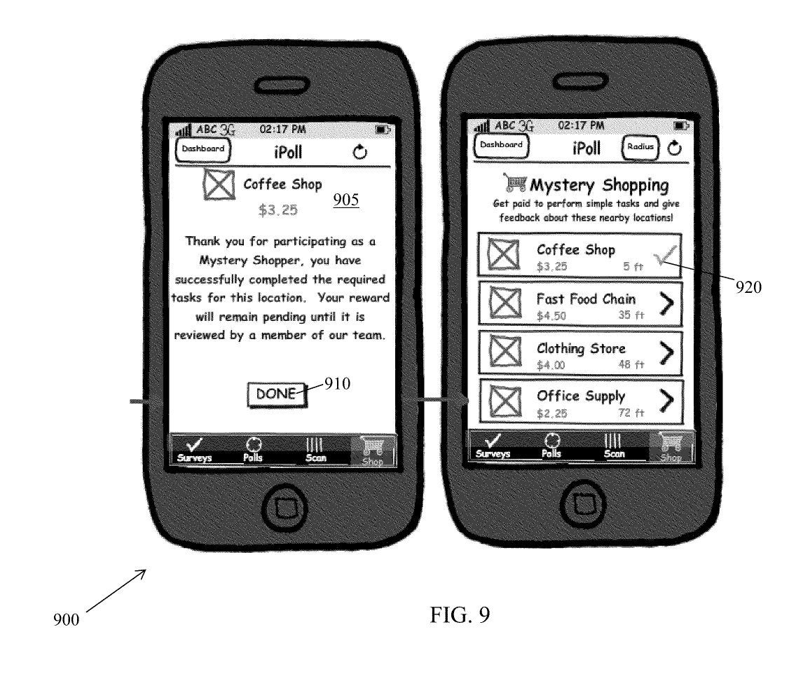

Referring now to FIGS. 6-9, user interfaces for selecting and processing task offers are shown and described. From an open application, a user may select a radius, corresponding to a distance, from a drop-down menu 605. The mobile device 350 may send the radius and location of the mobile device to the vendor task client application 365 on the server 305. The mobile device 350 may receive and display task offers 610a, 610b, 610c, 610d for vendors with enterprises within the radius of the user. The display may include the names of vendors, the distances to the enterprises, and the amount of compensation the user would receive for completing the task offer. In this example, the task offers 610 may be for a coffee shop 610a, a fast food chain 610b, a clothing store 610c, and an office supply store 610d.

A user may select a task offer by pressing an area of the mobile device's 350 touch screen corresponding to the task offer. If the user selects the task offer for the coffee shop 610a, the mobile device 350 may display the tasks 615, 620, 625 for the task offer. For provide data for a task 615, 620, 625, the user may touch an area of the device's 350 touch screen corresponding to the task. The mobile device 350 may display a control 630, such as a submit button, for sending information about the tasks to the server 305. The control 630 may be inactive until the user completes all the tasks in the offer.

When the user selects the task 615 for purchasing an item and capturing an item of the receipt, the vendor task client application 365 on the mobile device 350 may access the device's 350 camera function. The user may capture an image of the receipt for a purchased item. The image may be stored on the mobile device 350. Upon image capture, the mobile device 350 may display the tasks 615, 620, 625 for the task offer. The mobile device 350 may display a symbol 710 indicating that task 615 has been completed.

The user may select the task 620. The mobile device 350 may display a request for the user to check the cleanliness of the bathroom. The request may include possible conditions of the bathroom and radio buttons next to each of the conditions 715a, 715b, 715c, 715d (collectively, 715). A user may select the radio button corresponding to the user's answer. The user may select the control 720 to save the answer on the device 350.

Upon recordation of the answer, the mobile device 350 may return to the display of the tasks 615, 620, 625. The mobile device 350 may display a symbol 805 indicating that task 620 has been completed. The user may select the task 625. The mobile device 350 may display questions for the user to answer. The questions may require yes/no answers and radio buttons next to each of the answers, 810, 815. A user may select the radio buttons corresponding to the user's answers. The user may select the control 820 to save the answer on the device 350.

Upon recordation of the answers, the mobile device 350 may return to the display of the tasks 615, 620, 625. The mobile device 350 may display a symbol 825 indicating that task 620 has been completed. Because all of the tasks have been completed, the control 630 for submitting the data for the tasks may become active. A user may select the control 630 to send the data to the server 305. The mobile device 350 may submit the data to the server 305.

The server 305 may send a user interface 905 to the mobile device 350 acknowledging receipt of the data. The mobile device 350 may display the user interface 905. The user interface 905 may include a control 910 which the user may select to indicate the user has received the message on the interface 905. The mobile device 350 may return to the display of task offers 610. The display may include a symbol 920 indicating that the task offer for the coffee shop 610a has been completed. The user may select any other task offer, and the mobile device 350 will obtain the tasks from the server 305.

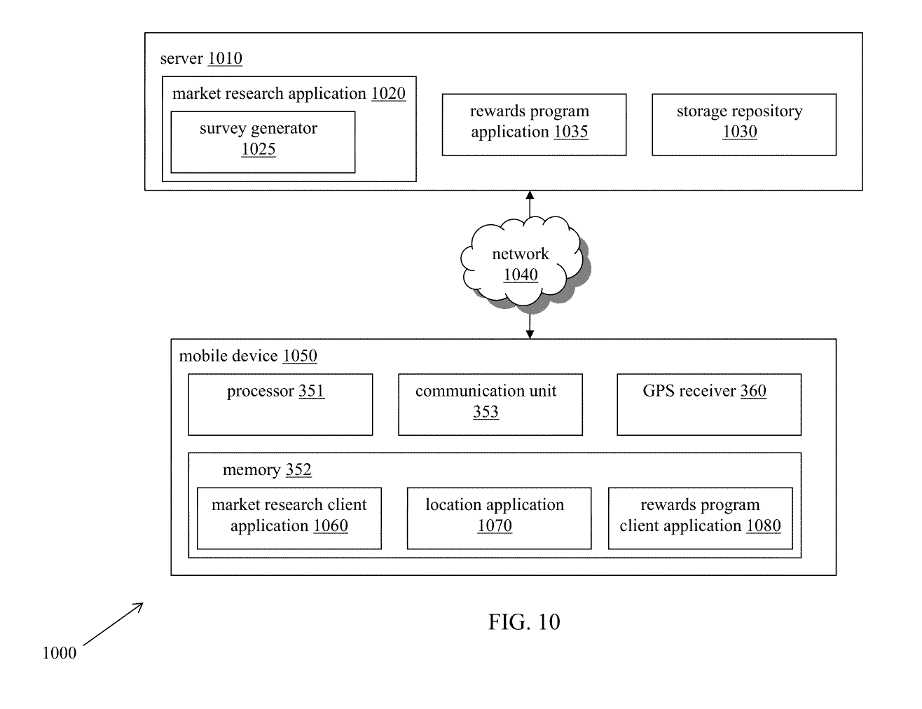

Referring now to FIG. 10, an exemplary system 1000 for deploying a location based market research program and/or a location based rewards program is shown and described. In some implementations, components of the system 1000 may be used with components of the system 300. Components of the system 1000 may operate according to similar components of system 300 (e.g., the systems' location applications 365, 1070 may operate in substantially the same manner). In some implementations, components of the systems 300, 700 may be combined into a single system (e.g., server 1010 may include the vendor task offer application 316).

The system 1000 may include a server 1010 that communicates with a mobile device 1050 over a network 1040. The server 1010, in some implementations, can comprise a storage repository 1030 and can execute a market research application 1020, a survey generator 1025, and a rewards program application 1035. The mobile device 350, in some implementations, can execute a market research client application 1060, a location application 1070, and a rewards program client application 1080.

Further referring to FIG. 10, and in more detail, in some implementations the server 1010 can be any computer including any computing machine 100 or 200 described herein. The server 1010 can be any type of server. For example, the server 1010 can be an application server, a file server, a proxy server, an appliance, a gateway server or any other server-type able to carry out the methods and systems described herein. In some implementations, the server 1010 can be a logical grouping of one or more servers which can be referred to as a server farm. Any one of the servers included within the logical grouping of servers can include a storage repository 1030 and can execute a market research application 1020, a survey generator 1025, and a rewards program application 1035. Instructions for the applications 1020, 1025, 1035 may be stored in a memory, and a processor (not shown) can execute the instructions. In some implementations, the server 1010 can be referred to as a remote computer or remote computing environment.

The mobile device 1050 can be any computer or mobile device including any computing machine 100, 200 described herein or the mobile device 350 described in reference to FIG. 3. For example, the mobile device 1050 may include the GPS receiver 360 of FIG. 3. The mobile device 1050 may include a communication unit 353. In some implementations, the communication unit 353 may communicate with cellular networks and/or computer networks. In some implementations, the mobile device 1050 can be a mobile device such as a tablet computer, a smart phone, a mobile phone, a personal digital assistant, or any other mobile device that has a processor and is able to carry out the methods and systems described herein.

In some implementations, the mobile device 1050 and the server 1010 can communicate over a network 1040. The network 1040 can be any network 1040 and in some implementations can be a local area network (LAN), a wide area network (WAN), a primary network, a sub-network, a public network, or a private network. In some implementations, the network can be a wireless network. In some implementations, the network can be a cellular network. The network can be a computer network. In some implementations, the network can have any network topology.

In some implementations, the server 1010 can execute a market research application 1020 that issues market research surveys to a user's mobile device 1050, gathers market research data from a user's mobile device 1050 and tracks market research data for one or more users. In some implementations, the market research application 1020 can be an application published by UNITED SAMPLE, INC. In some implementations, the market research application 1020 may be obtained from a centralized location for marketing mobile device 350 applications.

The market research application 1020 can communicate with a market research client application 1060 executing on a user's mobile device 1050 to obtain market research data about the user that uses the mobile device 1050. For example, the market research application 1020 can transmit user interfaces to the market research client application 1060 which can then display the received user interfaces on a display of the mobile device 1050. In some implementations, the market research application 1020 can transmit application data to the market research client application 1060 which can use the application data to generate surveys and user interfaces. Furthermore, the market research application 1020 can store and manage: user data; market research information obtained from a mobile device 1050; survey data; mobile device 1050 location information; survey information; vendor information; vendor statistics; vendor market research data; or any other information required to carry out the methods and systems described herein.

The market research application 1020 can communicate with mobile devices 1050 as well as vendors. In some implementations, a vendor can obtain user information and other market research that is relevant to a product or service provided by the vendor. Thus, in some instances the market research application 1020 interfaces with mobile devices 1050 accessed by users and with one or more computers maintained by a vendor.

The vendor, in some implementations, can be a third party that requests market research information from the market research application 1020. In one implementation, the vendor can interact with the market research application 1020 to configure an aspect of the market research application 1020. Configuring an aspect of the market research application 1020 can include indicating when and how many surveys a vendor would like transmitted to a user. In some implementations, the vendor can configure when, during the timeline of a transaction, to transmit a survey to the user. These configurations can be coded into the market research application 1020 through a configuration user interface or using a script.

In some implementations, the market research application 1020 can execute a survey generator 1025 that generates market research surveys. Surveys can be generated using vendor-specified information and guidelines. This information and guidelines can be any of the following: information about the vendor's products/services; guidelines that indicate what type of market research the vendor would like to perform; guidelines about types of questions to ask users or consumers; information about the vendor; information about a typical consumer; or any other relevant information or guideline that can be used to generate a survey. In some implementations, the surveys can be pre-generated or can be generated according to a survey template comprising vendor information and guidelines. When the survey is pre-generated, the survey generator 1025 may obtain the pre-generated survey from a storage repository 1030 rather than generate a survey responsive to a user's actions or responsive to user data. While FIG. 10 illustrates a market research application 1020 that includes a survey generator 1025, in some implementations the market research application 1020 can carry out the functionality of the survey generator 1025.

The market research application 1020 and survey generator 1025, in some implementations, can communicate with the storage repository 1030 to obtain vendor information, vendor guidelines, survey information, user information, or other similar types of information. In some implementations, the market research application 1020 and survey generator 1025 can communicate with the storage repository 1030 to store market research data, survey results, user information and vendor guidelines and information.

The server 1010 can comprise a storage repository 1030 that can store information generated or obtained by the market research application 1020, the survey generator 1025 or the rewards program application 1035. In some implementations, the storage repository 1030 can comprise one or more databases, tables or other storage elements.

Each mobile device 1050, in some implementations, can execute a market research client application 1060 that can communicate with a market research application 1020 executing on a remote server 1010. When a user of the mobile device 1050 wishes to install the market research application, the user can establish a connection with the market research application 1020 and request executable installation instructions. The market research application 1020 can respond to this request by transmitting or streaming the market research client application 1060 to the mobile device 1050. In turn, the mobile device 1050 can receive the streamed application and can install the application on the mobile device 1050. The market research client application 1060 can be obtained from a website, application store, email or other electronic source available on the mobile device 1050. In some implementations, installing the market research client application 1060 can include setting up a user account where a user can specify any of the following information: user identifier; user password; user information; user preferences; or any other similar information. When a user has a pre-existing account or multiple pre-existing accounts, the user can select which account the user would like to associate with that particular market research client application 1060. For example, the user can be registered to access a rewards program issued and managed by the third party that provides the market research application(s) 1020, 1060. In this example, the user already has an account with the third party and can therefore choose to associate that account with the market research client application 1060 or create a new account.

A market research client application 1060, in some implementations, locally executes on the mobile device 1050 to generate market research surveys, obtain a user's response to market research surveys, obtain the location of a user, provide the user with information regarding opportunities to provide feedback about a vendor, and establish a communication link with the market research application 1020. Furthermore, the market research client application 1060 can provide a user interface or portal through which a user can manage his/her settings and account. Management can include managing user information (e.g. home address, age, interests, gender, education level, etc.), managing a user identifier and/or user password, or managing a user's configuration settings. Configuration settings can include: a value indicating how many times a user wishes to receive market research surveys; an excluded list through which the user can prevent particular market research surveys from being sent to the user; a favorites list within which the user can specify a list of favorite vendors; or other similar configuration information.

In some implementations, the market research client application 1060 can include a user interface component through which a user can interact with both the client application 1060 and the market research application 1020. This user interface component can be accessed once a user logs into the market research application 1020, and can be populated with surveys and vendor information. In some implementations, the surveys, vendor information and in some instances the user interface information can be transmitted or streamed to the market research client application 1060 from the market research application 1020. Thus, the market research application 1020 can obtain user location information or user input and can responsively transmit or stream surveys, vendor information or user interface information to the mobile device 1050.

The server 1010 can further execute a rewards program application 1035. In some implementations, the rewards program application 1035 can execute in conjunction with the market research application 1020 to issue rewards to users that participate in surveys issued by the market research application 1020. Some implementations include a rewards program application 1035 that enrolls users in rewards programs designed to foster consumer loyalty and reward consumers for purchasing a particular vendor's products or services. The rewards program application 1035 can track user participation by tracking a user's purchases and tracking whether a user chooses a particular vendor when the user is in a geographic area.

In some implementations, the mobile device 1050 can execute a rewards program client application 1080 that can communicate with the rewards program application 1035 executing on the server 1010. The rewards program client application 1080 can execute a local version of the rewards application 1035 and can obtain rewards program information and display the information to a user of the mobile device 1050. In some implementations, the rewards programs and vendor information displayed by the rewards program client application 1080 can be obtained from the rewards program application 1035. Similarly, the rewards program application 1035 can transmit or stream to the mobile device 1050 a rewards program client application 1080 which can be used to locally execute rewards programs stored and managed by the rewards program application 1035.

The mobile device 1050 can further execute a location application 1070 that can be used to determine the location of the mobile device 1050. In some implementations, determining the location of the mobile device 1050 can include determining the coordinates of the mobile device 1050 on a global map. The mobile device 1050, in some implementations, can obtain its location using a global positioning system (GPS). In some implementations, the location application 1070 can be a GPS application, while in some implementations the location application 1070 can interface with a GPS application to obtain the geographic location of the mobile device. A GPS application, in some implementations, can obtain the geographic location of the mobile device 1050 from a satellite. This can be accomplished by transmitting a signal to a satellite, receiving a return signal from the satellite, and using trilateration to determine the coordinates of the source of the signal, e.g. the mobile device 1050. A mobile device's location can be described in terms of the mobile device's coordinate location on a global map, e.g. the latitude and the longitude of the location of the mobile device 1050 on the globe. While the location application 1070 can execute on the mobile device 1050 at the request of an application executing on the mobile device 1050, in some implementations the server 210 can instruct the location application 1070 to obtain the location coordinates of the mobile device.

In some implementations, the mobile device's location can be obtained from a third party application able to obtain mobile device location information. In one implementation, the mobile device location and the surrounding businesses and services can be obtained from a third party application such as FOURSQUARE, FACEBOOK, GOOGLE MAPS, BOOYA or any other application able to obtain position information for a mobile device and use that information to obtain business and service information.

The mobile device 1050 may include a market research client application 1060. In some implementations, mobile device 1050 may include an application in which participation in market research may be a function and/or subapplication. In some implementations, a user may obtain the market research client application 1060 from a website or centralized location, as described herein. Purchasing and/or requesting the market research client application 1060 may initiate a download from the centralized location to the mobile device 1050.

In operation, a user of the mobile device 1050 may request a display of at least one program to complete market research (also referred to herein as “research program”). In some implementations, the user may make the request by opening the market research client application 1060 on the device 1050 or accessing a function of an open application, according to any of the methods described herein. The application 1060 may require the user to enter credentials (e.g., username, password).

In response to the user's request, the location application 1070 on the mobile device 1050 may determine the device's location, according to any of the methods described herein. In some implementations, the location may include coordinates. The coordinates may correspond to the device's 1050 position on the surface of the earth. The coordinates may include Cartesian coordinates. The location may include coordinates for latitude and longitude. In some implementations, the location may include an address corresponding to the coordinates for the location.

The location application 1070 may send the location to the server 1010. In some implementations, the mobile device 1050 may send the username of the user of the device 1050. In some implementations, the mobile device 1050 may send an identifier of the device 1050 (e.g., device serial number). The mobile device 1050 may send any of the information described herein to the market research application 1020 on the server 1010.

The server 1010 may identify a user based on the username and/or identifier of the device 1050. The server 1010 may associate the location and the user. In some implementations, the server 1010 may retrieve a user profile associated with the user from the storage repository 1030. The user profile may include any information about the user. For example, the user profile may include the user's gender, age, income level, city of residence, or any other demographic information. In some implementations, the user profile may include a radius (e.g., a maximum distance between the user and vendors' enterprises for which research programs should be displayed to the user).

In some implementations, the market research application 1020 may identify at least one vendor research program based on the location of the mobile device 1050 and/or the user profile. The application 1020 may identify vendors with at least one enterprise (e.g., retail store, franchise) within a threshold distance of the device 1050. In some implementations, the application 1020 may query the storage repository 1030 for research programs associated with vendors with an enterprise within the threshold distance, according to any of the methods described herein. The threshold distance may be determined according to any of the methods described herein.

In some implementations, the market research application 1020 may identify a subset of the research programs to present to the user. For example, the application 1020 may apply one or more filters to the research programs associated with vendors with enterprises within a threshold distance of the user. Exemplary filters include categories of vendors (e.g., fast food restaurants, retail clothing stores, airports, coffee shops). For example, the market research application 1020 may identify research programs associated solely with fast food restaurants.

In some implementations, the application 1020 may identify research programs based on information in the user profile. The information may include data on the user's demographic group. The market research application 1020 may identify research programs based on vendors' needs for data from various demographic groups. For example, a vendor may indicate a need for market research for men with annual income levels between $50,000 and $100,000, but not on men with annual income levels between $100,000 and $200,000. In another example, a vendor may indicate a need for market research for women between the ages of 21 and 35 who live in suburban areas, but not for women in the same age bracket who live in urban areas. The market research application 1020 may identify research programs for which the vendors' targeted demographic group for the programs matches the user's demographic information.

In some implementations, more than one research program may be associated with a vendor. The application 1020 may identify one of the research programs based on the user profile. For example, a vendor may have research programs with different questions for users with different demographic information. The application 1020 may identify the vendor's research program that corresponds to the user's demographic information.

The profile may include behavioral information about the user. For example, the profile may include a list of vendors for which the user is already a repeat customer. The application 1020 may rank the research programs according to the list. In some examples, the profile may include the research programs the user has previously completed. The research programs the application 1020 has identified based on location may include conditions regarding the user's past behavior. For example, a research program may indicate that a user may not participate in the research if the user has already conducted the same research a predetermined number of times within a period of time (e.g., the user has already performed the research three times in the past week).

In some implementations, the application 1020 may obtain research programs for identified vendors with at least one enterprise within one or more threshold distances of the user. For example, the application 1020 may retrieve the research programs from the storage repository 1030. In some implementations, the research program may include an amount of compensation for a user who completes the research program. The compensation may be any form of compensation described herein.

The research program may include a single amount of compensation. The research program may include different amounts of compensation and conditions associated with each amount. Conditions may include requirements regarding demographic information (e.g., vendors may program different amounts of compensation to encourage participation from members of demographics for which the vendors may have less information), as described herein.

The application 1020 may send descriptions of the research programs to the mobile device 1050. Each description may include the name of the vendor, the address of the vendor's enterprise, and/or an amount of compensation for completing the research requested by the vendor. The mobile device 1050 may display a list of the research programs.

The user may select a research program according to any of the methods for select offers or programs described herein. The market research client application 1060 may send the selection to the market research application 1020 on the server 1010. In some implementations, upon the user selection of the research program, the location application 1070 may obtain the device's 1050 location. The location application 1070 may send the updated location to the server 1010. The market research application 1020 on the server 1010 may determine the user remains within a threshold distance of the enterprise before sending the inquiries of the research program to the mobile device 1050.

In some implementations, the market research application 1020 on the server 1010 may obtain the first inquiry of the selected research program and process the inquiry for display, according to any of the methods described herein. Inquiries may include questions regarding the user's experience at the enterprise. For example, an inquiry may ask what motivated a user to go to the enterprise. An inquiry may ask about the extent of crowdedness in the enterprise. An inquiry may ask about the number of cashiers available to service customers in a retail store. An inquiry may ask if the user made a purchase, and why or why not. An inquiry may ask the user for demographic information about himself or herself (e.g., age, gender, residence, income bracket). An inquiry may ask the user about his or her consumption patterns (e.g., use of product and/or service, frequency of use). An inquiry may ask the user regarding customer traffic at the enterprise and at a competing vendor's nearby enterprise.

The user may input a response to the first inquiry into the mobile device 1050. In some implementations, the market research client application 1060 may measure a period of time that elapses between display of the inquiry and the user's entry of the response. In some implementations, the client application 1060 may append a time, date, and/or location of entry to the response. The client application 1060 may send the response to the server 1010.

The market research client application 1060 may determine the acceptability of the response according to any of the methods described herein. In some implementations, the market research client application 1060 may notify the mobile device 1050 that the response is unacceptable. The application 1020 may send the device 1050 a notification for display. The application 1020 may request or not request a resubmission of a response. In some implementations, if a response is unacceptable because the user is providing nominal responses, the application 1020 may determine the user is an uncredible source of information and terminate the research program.

The market research application 1020 may obtain the next inquiry of the research program. The mobile device 1050 may display the inquiry and the user may respond according to any of the steps described herein. The applications 1020, 1060 may perform any of the steps described herein for each inquiry in the research program.

After the market research application 1020 has received responses for all the inquiries of the market research program, the application 1020 may determine whether the amount of compensation should be allocated to the user. The application 1020 may determine the compensation should be allocated when all the user responses are acceptable. The application 1020 may determine the compensation should be allocated when a threshold number and/or percentage of responses are acceptable user submitted data is acceptable, according to any of the steps described herein. In some implementations, the application 1020 may determine compensation should not be allocated when a user's response to an inquiry indicates the user is not a member of the vendor's target demographic group. In some implementations, the application 1020 may determine compensation should not be allocated when a user's response to an inquiry indicates the user does not fulfill at least one condition for the market research program (e.g., ownership and/or regular use of a product, residency in an identified area, completion of the research program within a threshold period of time and/or threshold distance from the enterprise).

The application 1020 may increase an account associated with the user by the amount of compensation. The application 1020 may notify the user according to any of the steps described herein.

In some implementations, while the market research client application 1060 is active, the location application 1070 may determine the device's 1050 location on a periodic basis (e.g., once every 3 minutes, 10 minutes). The location application 1070 may send the updated location to the market research application 1020 on the server 1005. The application 1020 may determine research programs available within the threshold distance(s) of the updated location. The application 1020 may send descriptions of the updated task programs to the mobile device 1050 for display.

In some implementations, the market research application 1020 may identify a research program associated with a vendor with an enterprise that is not within a threshold distance of the device 1050. The market research client application 1060 may notify the user that the research programs may become available once the user moves within the threshold distance to the enterprise.

In some implementations, the market research application 1020 may send all the user interfaces for all the requests for data in a research program to the mobile device 1050, as described herein. In some implementations, the mobile device 1050 may store data from the user if the device 1050 cannot communicate with the market research application 1020 and send the data when communication resumes, as described herein. In some implementations, the market research client application 1060 may be embedded in an application for a third-party.

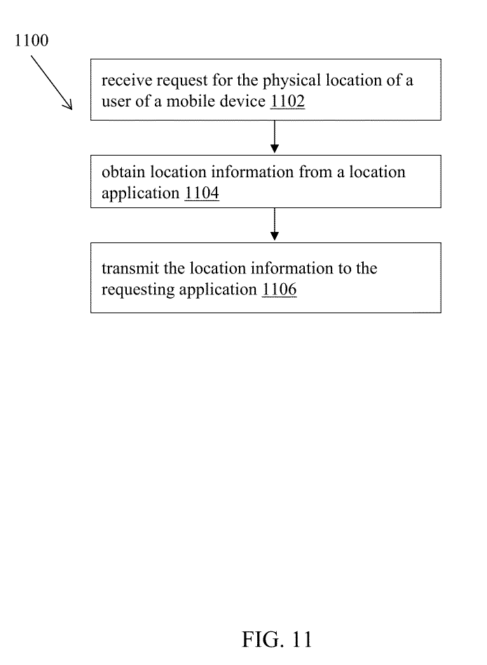

Referring now to FIG. 11, a flow diagram of an exemplary method 1100 for determining the location of a user of a mobile device is shown and described. Although the steps are described herein with reference to mobile device 1050, the mobile device 350 described in reference to FIG. 3 may perform the steps, as may any other mobile device.

A mobile device 1050 can receive a request for the physical location of the mobile device 1050 (Step 1102). Upon receiving the location request, the mobile device 1050 can query a location application 1070 for the device's physical location and can obtain from the location application 1070 location information indicating the physical location of the mobile device 1050 (Step 1104). The mobile device 1050 can then transmit the obtained location information to the application or device that requested the information (Step 1106).

In more detail, in some implementations the mobile device 1050 can receive a request for the physical location of a user of a mobile device 1050 (Step 1102). In some implementations, this request can be issued by a market research application executing on a remote computer or server 1010. In some implementations, this request can be issued by a market research application 1020 in response to a user's request for market research surveys. In still some implementations, this request can be issued by a rewards program application 1035 in response to a user's request for consumer reward programs. The request for the physical location of the user of the mobile device 1050 can be a request for the physical location of the mobile device. This physical location can include the latitude and longitude of the mobile device. In some implementations, the physical location can be described in terms of the mobile device's proximity to a landmark or object. For example, the mobile device's location can be described in terms of the mobile device's proximity to a radio tower or satellite. The request can be issued in response to user input, e.g. a user executing an application or selecting a program. In some implementations, the request can be transmitted on a periodic basis.

Upon receiving the request, the mobile device 1050 can obtain location information from a location application 1070 (Step 1104). In some implementations, the location application 1070 executes on the mobile device 1050 and can therefore transmit location information to other applications executing on the mobile device 1050 through application program interfaces or other means of transmitting data amongst applications. In one implementation, the location application 1070 executes on a remote computer. In this implementation, the mobile device 1050 obtains the location information by issuing a request for the location information to the remote computer. The remote computer, in response to the request issued by the mobile device 1050, transmits the mobile device's location information to the mobile device 1050. The remote computer, in some implementations, is the server 1010.

The mobile device 1050 can transmit the location information to the requesting application (Step 1106). In some implementations, the mobile device 1050 transmits the location information to the market research application 1020 executing on the server 1010. In some implementations, the mobile device 1050 transmits the location information to the rewards program application 1035 executing on the server 1010.

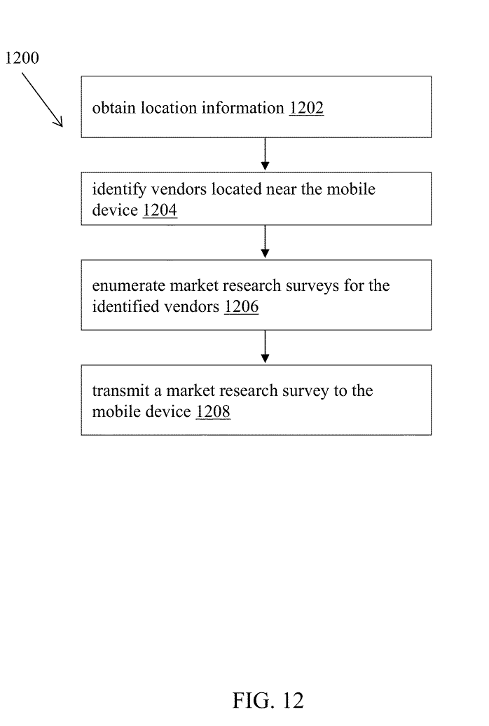

Referring now to FIG. 12, a flow diagram for an exemplary method 1202 for identifying and transmitting market research surveys to a mobile device is shown and described. In some implementations, a market research application 1020 obtains location information from a mobile device 1050 (Step 1202). The market research application 1020 then identifies one or more vendors that are located near the mobile device 1050 (Step 1204), and enumerates market research surveys for those identified vendors (Step 1206). At least one of the enumerated market research surveys are then transmitted to the mobile device 1050 (Step 1208).

In more detail, the market research application 1020 may obtain location information from a mobile device 1050 (Step 1202). The location information obtained, in some implementations, can be the physical location of the mobile device 1050. Obtaining the information can include querying the mobile device 1050 for the coordinates of the mobile device 1050. When a mobile device 1050 receives a query for its coordinates, in some implementations the mobile device 1050 can respond by retrieving its location from memory or executing a location application 1070 that can retrieve the coordinate location of the mobile device 1050. Querying the mobile device 1050 for location information can include a server or other computer issuing a request for the physical location of the mobile device 1050, and then receiving the physical location information for the mobile device 1050. The location information can be obtained by a location application executing on the mobile device 1050. Once the location application 1070 obtains the physical location of the mobile device 1050, the location application 1070 can transmit the physical location of the mobile device 1050 to the market research application 1020. In some implementations, the market research application 1020 obtains the mobile device's location information from a storage repository on the server. In these implementations, the mobile device 1050 can periodically transmit its location to the server where the location information is stored in a memory location or storage repository.

Location information can be information describing the physical location of the mobile device 1050. The physical location can be described in terms of longitudinal and latitudinal coordinates. In some implementations, the physical location can be described in terms of the mobile device's proximity to a landmark such as a cell phone tower, base or vendor.

Upon obtaining the location of the mobile device 1050, the market research application 1020 can identify one or more vendors that are located near the mobile device 1050 (Step 1204). In some implementations, identifying the vendors can include querying a database for vendors that are located proximate to the mobile device 1050. Proximity can be determined based on a predefined distance range. For example, a proximity value could be a value that defines a proximate vendor as a vendor within a predetermined distance from the mobile device 1050. In one implementation, an application executing on the server can determine the distance between a vendor and the location of the mobile device 1050. Using this determined distance value, the market research application 1020 can determine whether the vendor is within a predefined distance range. For example, if the predefined distance range is five miles, the market research application 1020 may calculate the distance between all vendors and the mobile device 1050, and select those vendors that are within five miles of the mobile device 1050. The predefined distance range or proximity value can be a hard coded value or can be a value transmitted by a user.

In some implementations, identifying vendors can include searching through a database for vendors that have a location that is proximate to the location of the mobile device 1050. In some implementations, identifying vendors can include identifying all vendors in the same town as the town where the mobile device 1050 is located. In still some implementations, identifying vendors can include identifying all vendors having the same zip code as the zip code where the mobile device 1050 is located.

The market research application 1020, in some implementations, identifies proximate vendors by first approximating an address for the mobile device 1050. Approximating an address can include assigning an address to the mobile device 1050 based on the physical location of the mobile device 1050. This address can be the address of the landmark physically located closest to the mobile device 1050. In some implementations, the address can be determined based on the address information for those landmarks physically located closest to the mobile device 1050. In some implementations, the mobile device's approximate address is determined before the distance between the mobile device 1050 and potential vendors is determined.

Once the market research application 1020 identifies those vendors that are located near or proximate to the mobile device 1050, the market research application 1020 can enumerate market research surveys for the identified vendors (Step 1206). Enumerating the market research surveys can include obtaining the surveys from a database or other storage repository. The surveys, in some implementations, can be stored with a vendor identifier such that the surveys can be found by searching for an identified vendor. The identified vendors can have vendor identifiers, thus searching for market research surveys can include searching for the vendor identifiers of the identified vendors. Enumerating the surveys, in one implementation, includes querying a database for market research surveys that are associated with the identified vendors. In some implementations, enumerating market research surveys can include obtaining the relevant market research surveys and temporarily storing them in a buffer or other short-term memory location.

In some implementations, the market research application 1020 can transmit all the market research surveys to the mobile device 1050 (Step 1208). In some implementations, the market research application 1020 can transmit a subset of the enumerated market research surveys to the mobile device 1050. The market research application 1020 or another application executing on the server can transmit the surveys to a mobile device 1050. In some implementations, the surveys are transmitted to a market research client application 1060 executing on the mobile device 1050. In some implementations, the surveys are streamed to the mobile device 1050.

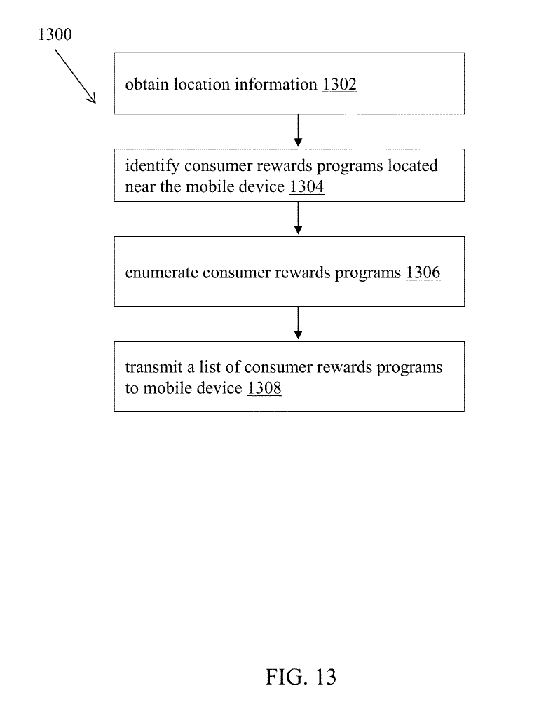

Referring now to FIG. 13, a flow diagram of an exemplary method 1300 for identifying consumer rewards programs located near a mobile device 1050 is shown and described. A rewards program application 1035 executing on a server can obtain the physical location of a mobile device 1050 (Step 1302) and identify those consumer rewards programs that are located near the mobile device 1050 (Step 1304). The rewards program application 1035 can then enumerate all the relevant consumer rewards programs (Step 1306) and transmit a list of relevant consumer rewards programs to the mobile device 1050 (Step 1308).

In more detail, in one implementation the rewards program application 1035 can obtain the physical location of the mobile device 1050 by obtaining the location information for the mobile device 1050 (Step 1302). The location information obtained, in some implementations, can be the physical location of the mobile device 1050. Obtaining the information can include querying the mobile device 1050 for the coordinates of the mobile device 1050. When a mobile device 1050 receives a query for its coordinates, in some implementations the mobile device 1050 can respond by retrieving its location from memory or executing a location application 1070 that can retrieve the coordinate location of the mobile device 1050.

Querying the mobile device 1050 for location information can include a server or other computer issuing a request for the physical location of the mobile device 1050, and then receiving the physical location information for the mobile device 1050. The location information can be obtained by a location application 1070 executing on the mobile device 1050. Once the location application 1070 obtains the physical location of the mobile device 1050, the location application 1070 can transmit the physical location of the mobile device 1050 to the rewards program application 1035. In some implementations, the rewards program application 1035 obtains the mobile device's location information from a storage repository on the server. In these implementations, the mobile device 1050 can periodically transmit its location to the server where the location information is stored in a memory location or storage repository.

Location information can be information describing the physical location of the mobile device 1050. The physical location can be described in terms of longitudinal and latitudinal coordinates. In some implementations, the physical location can be described in terms of the mobile device's proximity to a landmark such as a cell phone tower, base or vendor.

Upon obtaining the mobile device's physical location, the rewards program application 1035 can use this information to identify consumer rewards programs that are located near the mobile device 1050 (Step 1304). Identifying these rewards programs can first require the rewards program 1035 to identify vendors that are located near the mobile device 1050. The rewards program application 1035 can identify the vendors by querying a database for vendors that are located proximate to the mobile device 1050. Proximity can be determined based on a predefined distance range. For example, a proximity value could be a value that defines a proximate vendor as a vendor within a predetermined distance from the mobile device 1050. In one implementation, an application executing on the server can determine the distance between a vendor and the location of the mobile device 1050. Using this determined distance value, the rewards program application 1035 can determine whether the vendor is within a predefined distance range. For example, if the predefined distance range is five miles, the rewards program application 1035 may calculate the distance between all vendors and the mobile device 1050, and select those vendors that are within three miles of the mobile device 1050. The predefined distance range or proximity value can be a hard coded value or can be a value transmitted by a user.

In some implementations, identifying vendors can include searching through a database for vendors that have a location that is proximate to the location of the mobile device 1050. In some implementations, identifying vendors can include identifying all vendors in the same town as the town where the mobile device 1050 is located. In still some implementations, identifying vendors can include identifying all vendors having the same zip code as the zip code where the mobile device 1050 is located.

The rewards program application 1035, in some implementations, identifies proximate vendors by first approximating an address for the mobile device 1050. Approximating an address can include assigning an address to the mobile device 1050 based on the physical location of the mobile device 1050. This address can be the address of the landmark physically located closest to the mobile device 1050. In some implementations, the address can be determined based on the address information for those landmarks physically located closest to the mobile device 1050. In some implementations, the mobile device's approximate address is determined before the distance between the mobile device 1050 and potential vendors is determined.

Upon identifying vendors that are physically located near the mobile device 1050, the rewards program application 1035 can then identify those vendors that have rewards programs. Upon identifying those vendors that have rewards programs, the rewards program application 1035 can enumerate the consumer rewards programs (Step 1306) that are located near the mobile device 1050. Enumerating the proximate rewards programs can include determining which proximate vendors have rewards programs. In some implementations, this determination can further include determining whether a user of the mobile device 1050 qualifies for the identified rewards programs and enumerating those rewards programs that the user of the mobile device 1050 qualifies for.

The rewards program application 1035 can transmit a list of the enumerated rewards programs to the mobile device 1050. This list can include all enumerated consumer rewards programs or can include a subset of the enumerated rewards programs.

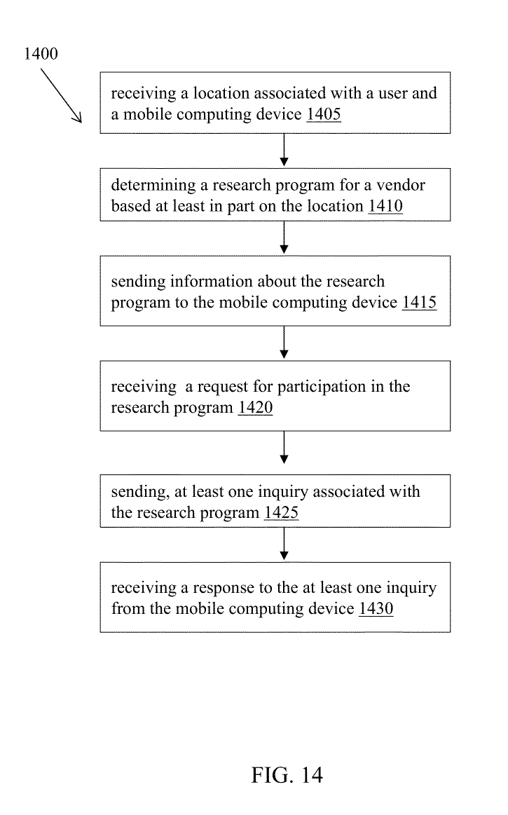

Referring now to FIG. 14, a flow diagram of an exemplary method 1400 for selecting and processing a research program is shown and described. The method may include receiving a location associated with a user and a mobile device (step 1405). A server 1010 may receive a location from a market research client application 1060 executing on a mobile device 1050. The location may include coordinates associated with the mobile device.

The method may include determining a research program for a vendor based at least in part on the location (step 1410). The market research application 1020 executing on the server 1010 may retrieve a location of an enterprise associated with a vendor. The application 1020 may retrieve the location from a storage repository. The application 1020 may determine a distance between the enterprise and the mobile device 1050. The application 1020 may compare the distance with a threshold (e.g., any of the threshold distances described herein). When the threshold exceeds the distance, the application 1020 may select the research program for the vendor.

In some implementations, the application 1020 may select a plurality of research programs for vendors with enterprises located within a threshold distance of the mobile device. The application 1020 may sort the plurality of research programs based at least in part on distances between the location of the mobile device 1050 and locations of the enterprises. The application 1020 may select a subset of the plurality of research programs based at least in part on the distances. For example, the application 1020 may select the research programs for the five closest enterprises to the mobile device 1050.

In some implementations, the application 1020 may select a research program based at least in part on information (e.g., demographic information, user participation in research programs) about the user. For example, a vendor may desire market research on an identified demographic group. If the vendor's desired demographic group matches the user's demographic information, the application 1020 may select the vendor's research program. In some examples, a vendor may refuse market research from users who have participated in its programs a predetermined number of times within a predetermined period of time. Thus, a user who has participated in two research programs for a vendor within the past twenty-four (24) hours may be ineligible for further participation in the vendors' programs. The application 1020 may not select research programs associated with the vendor.

In some implementations, the application 1020 may determine an amount of compensation for the user for participating in the research program. A vendor may determine different amounts of compensation for members of different demographic groups, according to the vendor's need for market research on the group. The application 1020 may determine an amount of compensation for the demographic group corresponding to the user.

The method may include sending information about the research program to the mobile device (step 1415). The application 1020 may send the information to the market research client application 1060 on the mobile device 1050. The information may include the identity of the vendor, a description of the research program, a location of an enterprise associated with the vendor, the distance between the enterprise and the mobile device 1050, the amount of compensation, and/or any other information described herein.

The method may include receiving a request for participation in the research program (step 1420). The request for participation may include a selection of a research program by the user. The market research application 1020 may retrieve from the storage repository the inquiries of the program. The method may include sending at least one inquiry associated with the research program to the mobile device (step 1425). The application 1020 may send a first, second, or any other inquiry of the research program to the mobile device 1050, according to any of the steps described herein.

The method may include receiving a response to the at least one inquiry from the mobile device (step 1430). The application 1020 may receive a response to any inquiry sent to the mobile device 1050. The application 1020 may determine the acceptability of any response, according to any of the steps described herein. In some implementations, the method may include increase an account of the user by an amount of compensation. The application 1020 may increase the account if the responses to the inquiries are acceptable.

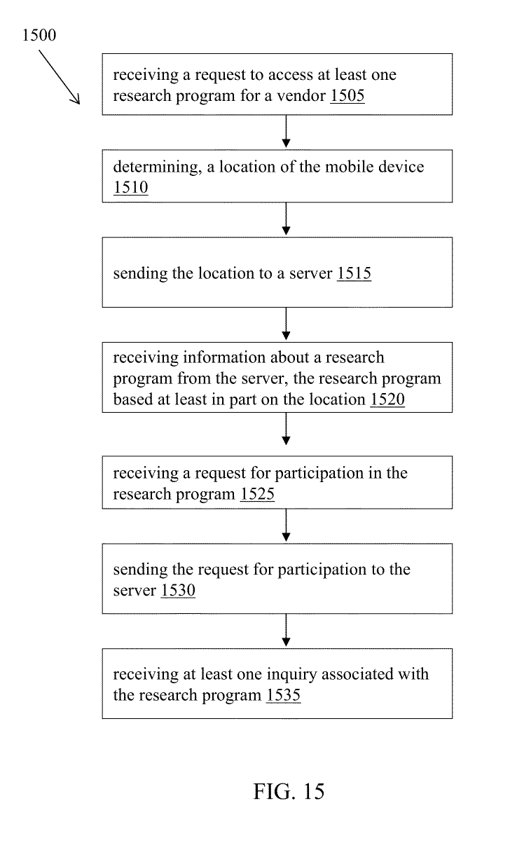

Referring now to FIG. 15, a flow diagram of an exemplary method 1500 for selecting and processing a research program is shown and described. The method may include receiving a request to access at least one research program for a vendor (step 1505). A mobile device 1050 may receive the request from a user. The user may make the request by opening a market research client application 1060 on a mobile device 1060, according to any of the steps described herein.

The method may include determining a location of the mobile device (step 1510). A location application 1070 executing on the mobile device 1050 may determine the location. The location application 1070 may determine the location according to signals from GPS satellites, cellular networks, computer networks, or any other system that includes location information. The location may include coordinates.

The method may include sending the location to a server (step 1515). The server 1010 may send the location to a market research application 1020 executing on the server 1010. The server may determine one or more research programs the user may participate in, based at least in part on the location, according to any of the steps described herein. The server 1010 may send information about the research programs to the mobile device 1050.

The method may include receiving information about a research program from the server, the research program based at least in part on the location (step 1520). Information about the research program may include the identity of the vendor associated with the program, a location of the vendor's enterprise, a distance from the user's location to the enterprise, a description of the research program, an amount of compensation for completing the research program, and/or any other information described herein. The mobile device 1050 may receive information about more than one research program.

The method may include receiving a request for participation in the research program (step 1525). The user may request participation in the research program by selecting the research program on the display, according to any of the steps described herein. The mobile device 1050 may receive the request. The method may include sending the request for participation to the server (step 1530). The mobile device 1050 may send the request for participation in the research program to the market researching application 1020 on the server 1010. In some implementations, the location application 1070 may update the device's 1050 location. The mobile device 1050 may send the location with the request for participation. The mobile device 1050 may send an identifier of the user (e.g., username).

The method may include receiving at least one inquiry associated with the research program (step 1535). In some implementations, the market research client application 1060 on the mobile device 1050 may receive a list of inquiries associated with the research program. The client application 1060 may receive an inquiry for display on the mobile device 1050. The inquiry may include a question and possible responses. The inquiry may include an open-ended question. The user may respond to the inquiry by selecting one of the possible responses (e.g., selecting a radio button corresponding to the response). The user may respond by entering text. The method may include sending a response to the at least one inquiry to a server.

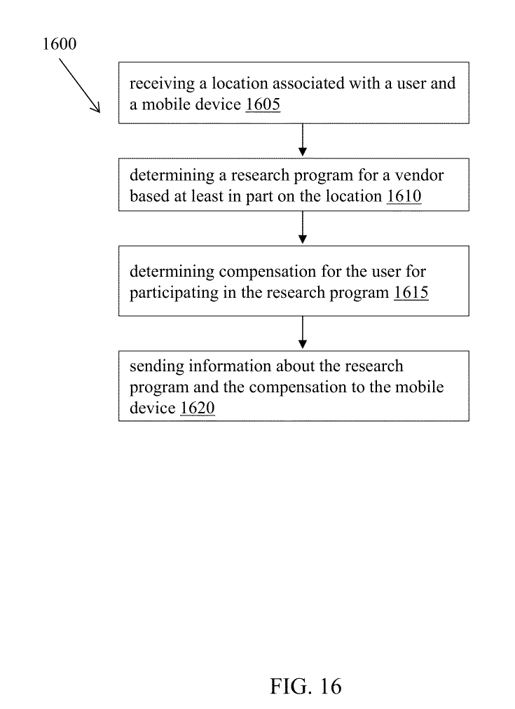

Referring now to FIG. 16, a flow diagram of an exemplary method 1600 for determining a research program and compensation for a user is shown and described. The method may include receiving a location associated with a user and a mobile device (step 1605). A research marketing application 1020 executing on a server 1010 may receive the location from a communication unit 353 of a mobile device 1050. The location may include the coordinates of the mobile device. The server 1010 may receive an identifier of the user (e.g., username). The server 1010 may receive an identifier of the mobile device 1050 (e.g., serial number). The server 1010 may determine the user from the user identifier and/or the mobile device 1050 identifier. The server 1010 may associate the location and the user.

The method may include determining a research program for a vendor based at least in part on the location (step 1610). In some implementations, a server 1010 may identify vendors with enterprises within a threshold distance of the user's location, according to any of the steps described herein. The server 1010 may select the research programs of the identified vendors.

In some implementations, the market research application 1020 may retrieve a location of an enterprise associated with the vendor. The application 1020 may compare a threshold (determined according to any of the steps described herein) with a distance between the location associated with the mobile device and the location of the enterprise. The application 1020 may select the research program for the vendor when the threshold exceeds the distance.

In some implementations, the market research application 1020 may select a plurality of research programs for vendors with enterprises located within a threshold distance of the location associated with the mobile device. The application 1020 may sort the plurality of research programs based at least in part on distances between the location of the mobile device and locations of the enterprises. For example, the application 1020 may rank and/or order the research programs according to the distances. The application 1020 may assign higher rankings to research programs associated with closer enterprises. The application 1020 may select a subset of the plurality of research programs based at least in part on the distances. For example, the application 1020 may select the research programs for the five closest enterprises to the user, although the application 1020 may select any number of research programs.

In some implementations, the market research application 1020 may determine the research program based at least in part on information about the user. Information about the user may include demographic information. For example, vendors may indicate needs for market data from targeted demographic groups, as described herein. In some implementations, only users from a demographic group identified by a vendor may be eligible for participation in a research program. When the user's demographic information matches the demographic group identified by the vendor, the market research application 1020 may select the research program.

Information about the user may include the user's participation in research programs. For example, vendors may limit the number of times users may participate in their research programs. A vendor may allow a user to participate in its research programs twice a week, although other conditions may be used. Thus, if a user has already participated in the vendor's research program twice in the past week, the market research application 1020 may not select the research program. If the user meets the vendor's conditions regarding past participation in research programs, the application 1020 may select the research program.

The method may include determining compensation for the user for participating in the research program (step 1615). The rewards program application 1035 may determine the compensation. In some implementations, the research program may indicate compensation for users who complete the research program. The compensation may include any of the types of compensation described herein. In some implementations, the research program may include the same amount of compensation for all users. In some implementations, users from different demographic groups may be eligible for different amounts of compensation, according to any of the steps described herein.

The method may include sending information about the research program and the compensation to the mobile device (step 1620). Information about the research program may include an identity of the vendor, an address of the enterprise associated with the vendor, a distance between the enterprise and the user/mobile device 1050, and/or any other information described herein. Information about the compensation may include the type of compensation and/or the amount of compensation for participating in and/or completing the research program.

The method may include receiving a response to at least one inquiry associated with the research program from the mobile device and determining acceptability of the response, according to any of the steps described herein. The method may include increasing an account of the user based at least in part on the compensation and the acceptability of the response, according to any of the steps described herein. The method may include re-sending at least one inquiry to the mobile device based on the acceptability of the response, according to any of the steps described herein.

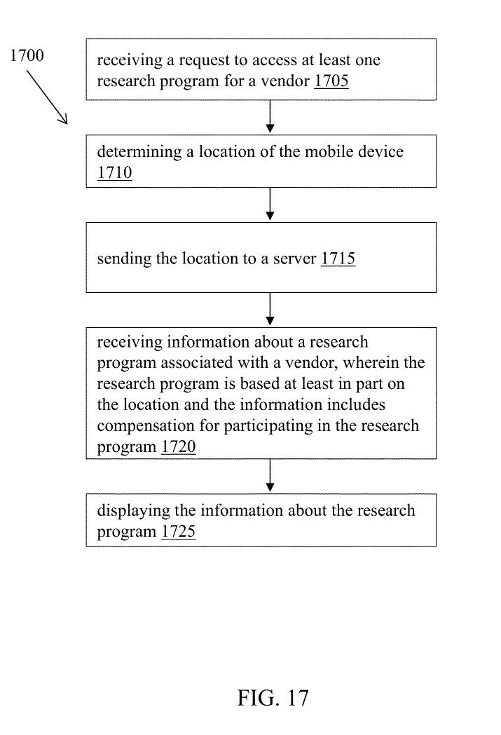

Referring now to FIG. 17, a flow diagram of an exemplary method 1700 for determine research programs and compensation for a user is shown and described. The method may include receiving a request to access at least one research program for a vendor (step 1705). A mobile device 1505 may receive the request according to any of the steps described herein. The method may include determining a location of the mobile device (step 1710). The mobile device 1505 may determine the location based on signals received from positioning satellites, cellular networks, computer networks, or any other type of network described herein. The mobile device 1505 may determine the location according to any of the methods described herein or any other method as would be appreciated by one of ordinary skill in the art. The location may include the coordinates of the mobile device 1505.

The method may include sending the location to a server (step 1715). A market research application 1020 and/or rewards program application 1035 executing on the server 1010 may receive the location. The market research application 1020 may determine a research program based at least in part on the location, according to any of the steps described herein. The rewards program application 1035 may determine compensation for participating in the research program, according to any of the steps described herein. The applications 1020, 1035 may send information about the research program and/or compensation to the mobile device 1050.

The method may include receiving information about a research program associated with a vendor from the server (step 1720). The research program may be based at least in part on the location, as described herein. Information about the research program may include compensation for participating in the research program, as described herein.

The method may include displaying the information about the research program (step 1725). The mobile device 1050 may display an identity of the vendor and a description of the research program. The mobile device 1050 may display an identity of the vendor, a description of the research program, and information about the compensation. The mobile device 1050 may display a distance between the location associated with the mobile device and a location of an enterprise associated with the vendor.

The method may include sending a response to an inquiry associated with the research program and receiving a message that the response has been rejected by the research program, according to any of the steps described herein.

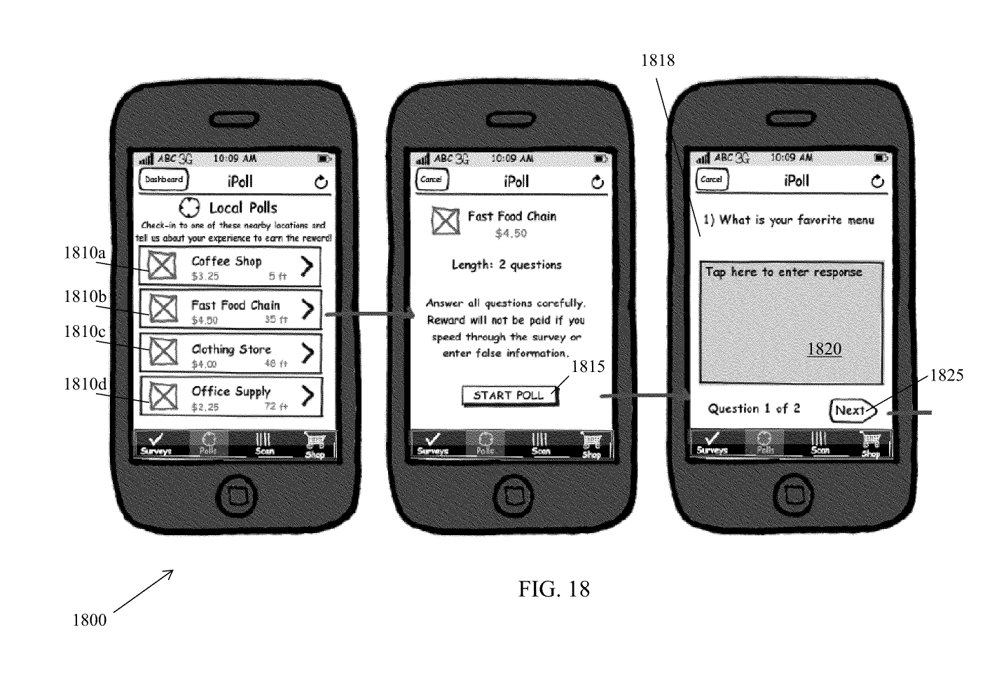

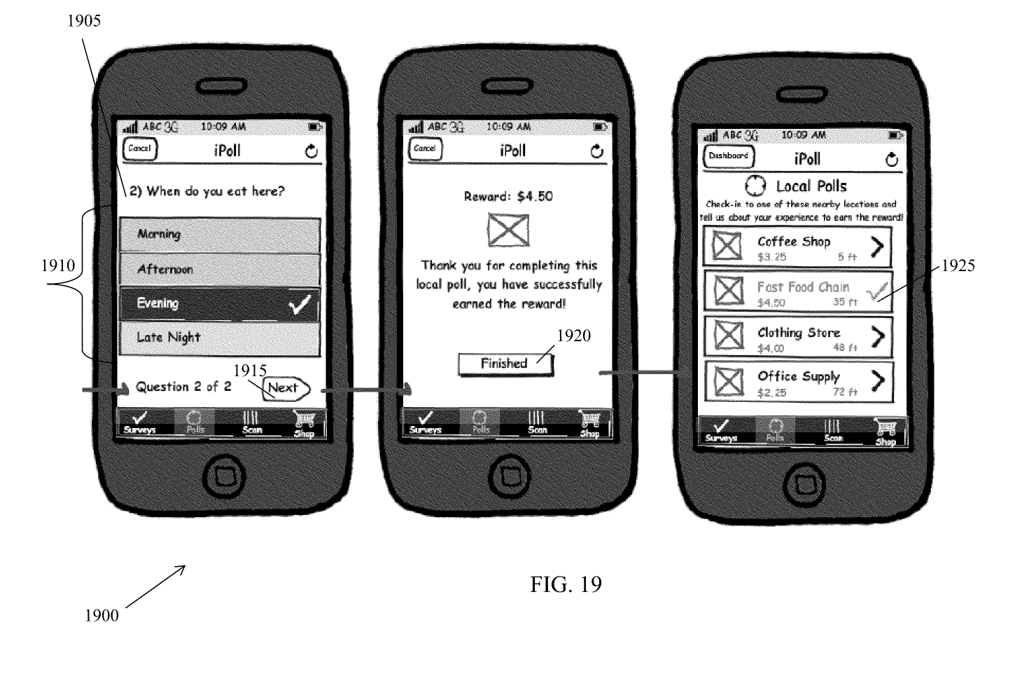

Referring now to FIGS. 18 and 19, exemplary user interfaces for selecting and processing research programs and compensation are shown and described. A market research client application 1060 executing on a mobile device 1050 may receive and display information about research programs for display. The information may include the identities of vendors associated with the research programs, the amounts of compensation for participating in the research programs, and the distances to the vendors' enterprises. In this implementations, the research programs 1810a, 1810b, 1810c, and 1810d may be associated with a coffee shop, fast food chain, clothing store, or office supply store, respectively. A user may request to participate in a research program by selecting an area on the device's 1050 touchscreen corresponding to the program.

In this implementation, the user may select the research program associated with the fast food chain. The mobile device 1050 may display a user interface describing the content of the research program (e.g., 2 questions). The user interface may include a notification that payment of the compensation may be contingent upon third-party satisfaction with the user's data. The user interface may include a control 1815 for starting the research program.

A user interface 1818 may display the first question of the market research program. The first question may be an open-ended question. The user interface 1818 may include a field 1820 in which the user may input his or her answer to the question. The user interface 1818 may include a control 1825, by which the user may access the next question in the research program. In some implementations, in response to selection of the control 1825, the mobile device 1050 may submit the user's response to the server 1010.

A user interface 1905 may display the second question of the market research program. The second question may include options 1910 for the response. The user may select one of the options. For example, the user may contact an area of the device's 350 touch screen corresponding to one of the options. The user interface 1905 may include a control 1915. In response to the user's selection of the control 1915, the mobile device 1050 may submit the user's selection of the option to the server 1010.

The market research application 1020 on the server 1010 may determine the acceptability of the user's responses, according to any of the steps described herein. The application 1020 may determine the responses are acceptable. The application 1020 may send a notification to the mobile device 1050 indicating the responses are acceptable. The notification may indicate that the user will receive the amount of compensation for completing the research program. The user may select a control 1920 to complete the research program. In response, the mobile device 1050 may display the research programs. The display may include a symbol 1925 indicating the research program for the fast food chain has been completed.

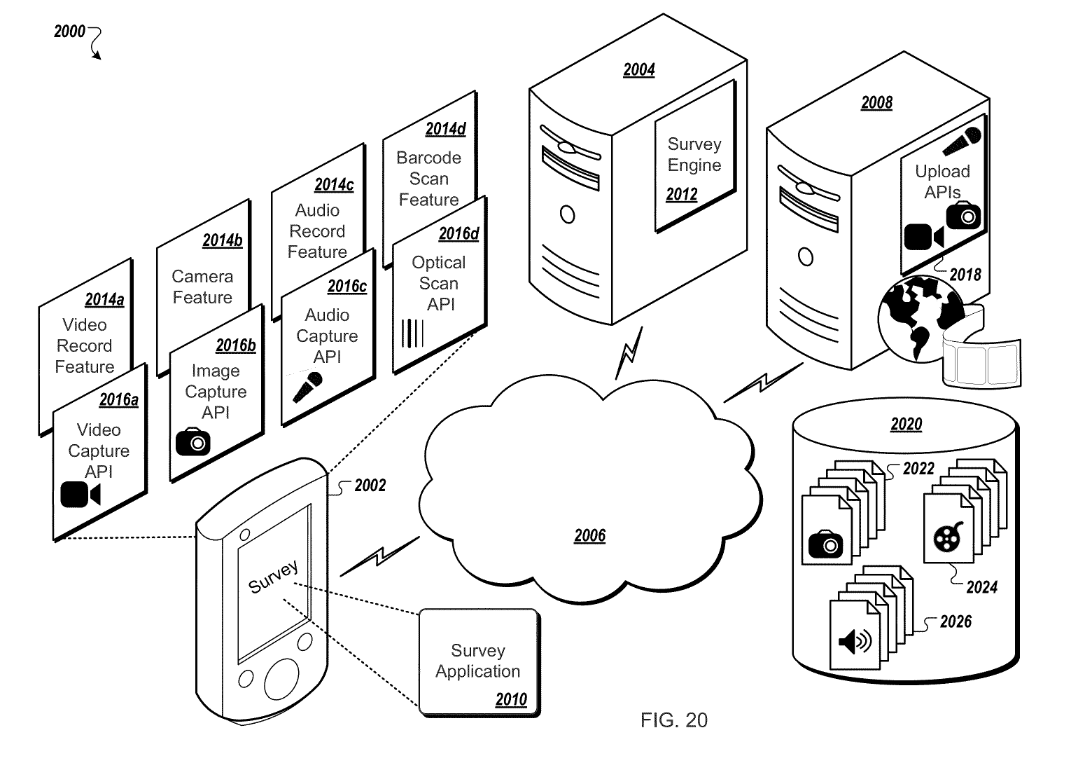

FIG. 20 is a diagram of an exemplary system 2000 for providing and processing survey questions by capturing data through a mobile computing device peripheral feature. A mobile computing device 2002 may be in communication with a server 2004 via a network 2006 for receiving consumer survey information via a survey application 2010 executing upon the mobile computing device 2002. In some implementations, a survey engine 2012 executing upon the server 2004 may provide offers for surveys to a user of the mobile computing device 2002. Upon acceptance of an offer by a user of the mobile computing device 2002, for example, the survey engine 2012 may provide survey information to the survey application 2010 of the mobile computing device 2002. The survey information, for example, may include one or more survey requests.

In some implementations, a response to a survey request may involve gathering data via a peripheral feature 2014 of the mobile computing device 2002. In some examples, the peripheral features 2014 may include a video recording feature 2014a, a camera feature 2014b, an audio recording feature 2014c, and a barcode scanning feature 2014d. The peripheral features 2014, in some examples, may refer to one or more built-in input devices (e.g., microphone, complementary metal-oxide-semiconductor (CMOS) active pixel sensor, camera-on-a-chip, charge-coupled device (CCD) sensor, radio-frequency identification (RFID) interrogator, etc.), firmware or software installed upon the mobile computing device 2002 for managing the functionality of the built-in input devices, and/or one or more applications installed upon the mobile computing device 2002 or built into the operating system of the mobile computing device 2002 for interfacing with built-in and/or tethered (e.g., via Bluetooth, RFID, USB, or other physical or logical connection) input devices. For example, a video recording feature 2014a may include coordination of hardware, software, and/or firmware components to record moving images. Additionally, in some implementations, the video recording feature 2014 may include coordination of hardware, software, and/or firmware components to record an audio track associated with the moving image. In other implementations, the audio record feature 2014c may be invoked for recording the audio track, as well as for recording an audio-only file. In some implementations, rather than providing a separate video recording feature 2014a, the camera feature 2014b may include coordination of hardware, software, and/or firmware components to record both moving and still images. A barcode scanning feature 2014d, in some implementations, may include coordination of hardware, software, and/or firmware components to optically scan and interpret machine-readable data from a variety of optical machine-readable data representations including, in some examples, a barcode, matrix barcode, 2D barcode, Quick Response (QR) code, and color barcode. In some implementations, the barcode scanning feature 2014d may make use of same or similar image capture components as the camera feature 2014b.

To enable response to a survey request using one of the peripheral features 2014, in some implementations, the survey application 2010 may make a call to one or more peripheral device application programming interfaces (APIs) 2016 such as, in some examples, a video capture API 2016a, an image capture API 2016b, an audio capture API 2016c, and an optical scanner API 2016d. In some implementations, a one-to-one correlation may exist between the peripheral device APIs 2016 and the peripheral device features 2014. For example, the video capture API 2016a may provide one or more commands for launching the video recording feature 2014a, the image capture API 2016b may provide one or more commands for launching the camera feature 2014b, the audio capture API 2016c may provide one or more commands for launching the audio record feature 2014c, and the optical scan API 2016d may provide one or more commands for launching the barcode scanning feature 2014d. In some implementations, one or more APIs 2016 may exist to access a single peripheral device feature 2014. For examples, a moving image capture API (not illustrated) may be used to invoke the video record feature 2014a without corresponding audio track, while the video capture API 2016a may be used to invoke the video record feature 2014a with corresponding audio track. Conversely, in some implementations, one API 2016 may exist to invoke two or more peripheral device features 2014. For example, the video capture API 2016a may be used to invoke the video record feature 2014a to record a moving image portion of a multimedia recording, as well as the audio record feature 2014c to record the audio portion of a multimedia recording.

In some implementations, one or more of the peripheral device APIs 2016 may be provided within the survey application 2010. In some implementations, a user may download and install the survey application 2010, for example from an application store available via the network 2006. In some implementations, one or more of the peripheral device APIs 2016 may be provided in the operating system of the mobile computing device 2002, for example to allow applications to interface with various features of the mobile computing device 2002.

In response to a survey request requesting data obtained through a particular peripheral device feature 2014, in some implementations, the survey application 2010 may intercept a call to a native peripheral device application and launch an interface to the particular peripheral device feature 2014, for example containing instructions regarding capture of information in response to the survey request. For example, in response to the selection of a control selecting the camera feature 2014b, the survey application 2010 may intercept user interface information associated with the image capture API 2016b and present the information within the construct of the survey application 2010.

Upon obtaining data via one of the peripheral device features 2014, the survey application 2010, in some implementations, may provide an interface for automatic upload of captured data. In some implementations, an API for automatic upload may format and relay data to a designated upload address, accessible via the network 2006. For example, the automatic upload API may automatically adjust a file size of a rich media file and direct the captured data to a media server 2008. In some implementations, the survey application 2010 may interface with an upload API 2018 provided by the media server 2008. While illustrated as separate servers, in some implementations, the media server 2008 may be included in the server 2004.

The media server 2008, in some implementations, may store the captured data in a media storage device 2020. The media storage device 2020, in some examples, may include one or more memory devices included within the media server 2008 and/or in communication with the media server 2008. As illustrated, the media storage device 2020 includes a set of image files 2022, a set of video files 2024, and a set of audio files 2026. The media storage device 2020, in some implementations, may store information regarding captured data. In some examples, information regarding captured data may include user or device information, a time stamp, a date, a geolocation, and an indication of a particular survey. In some implementations, information regarding captured data may be included within a meta data portion of a rich media file, for example a particular image file 2022, a particular video file 2024, or a particular audio file 2026. In some implementations, the media server 2008 may maintain a database of information regarding stored rich media files 2022, 2024, 2026. For example, a particular user record or survey identifier may be associated with two or more rich media files 2022, 2024, 2026.

In some implementations, the media server 2008 may process the captured data, for example to validate the data or to reformat the data into a standard format prior to storage. For example, the media server 2008 may analyze the contents of an image file to determine if a captured image is in focus, if the captured image is sufficiently bright, or if the captured image is likely to include one or more objects or other information requested by the survey. In a particular example, the media server 2008 may analyze the contents of the image file to determine that the image includes an image of a requested product or a requested corporate logo. In another example, the media server 2008 may analyze the contents of an audio file to determine if a captured audio file includes static or if a length of the audio file matches or exceeds a requested minimum recording length designated by the survey. In the example of barcode information, in some implementations, the media server 2008 may derive information corresponding to a provided product information code. For example, the media server 2008 may determine that the product information code correlates to a particular product name, product lot number, product type, product brand, product size and/or product expiration date. In other implementations, the survey application may validate rich media data prior to uploading to the media server 2008.

In the event of a corrupted rich media file or an otherwise unacceptable rich media file (e.g., audio length too short, image lacking an object identified as a requested subject, etc.), in some implementations, the survey application 2010 may provide the user with the opportunity to capture a replacement rich media file.

In some implementations, the media server 2008 may reformat the captured file into a standard format prior to storage, for example for comparison or storage size purposes. In some implementations, image files may be resized to a predetermined size prior to storage within the media storage device 2020. In some implementations, a rich media file 2022, 2024, 2026 may be compressed, appended with meta data, or otherwise adjusted prior to storage on the media storage device 2020.

In some implementations, upon success of upload (and, optionally, validation) of the captured file, the media server 2008 may communicate with one or both of the survey application 2010 and the survey engine 2012. For example, the media server 2008 may provide a product brand and/or product name to the survey engine 2012. Based upon this information, in some implementations, the survey engine 2012 may determine a follow-on request to provide to the survey application 2010. For example, if a particular product information code correlates to a national tooth paste brand, the survey engine 2012 may determine a follow-on request regarding mouthwash.

In a second example, the media server 2008 may provide a storage location of the rich media file 2022, 2024, 2026 to the survey engine 2012. The survey engine 2012, for example, may use the storage location to provide a preview of the rich media file 2022, 2024, 2026 to the survey application 2010. In another example, the media server 2008 may provide information to the survey application 2010 for preview of the stored rich media file 2022, 2024, 2026. In some implementations, the survey application 2010 may provide the user with a preview of the captured rich media file and the opportunity to capture a replacement rich media file. For example, the user may select a control to initiate capture of a replacement rich media file, or the user may select a control to approve of the preview of the rich media file.

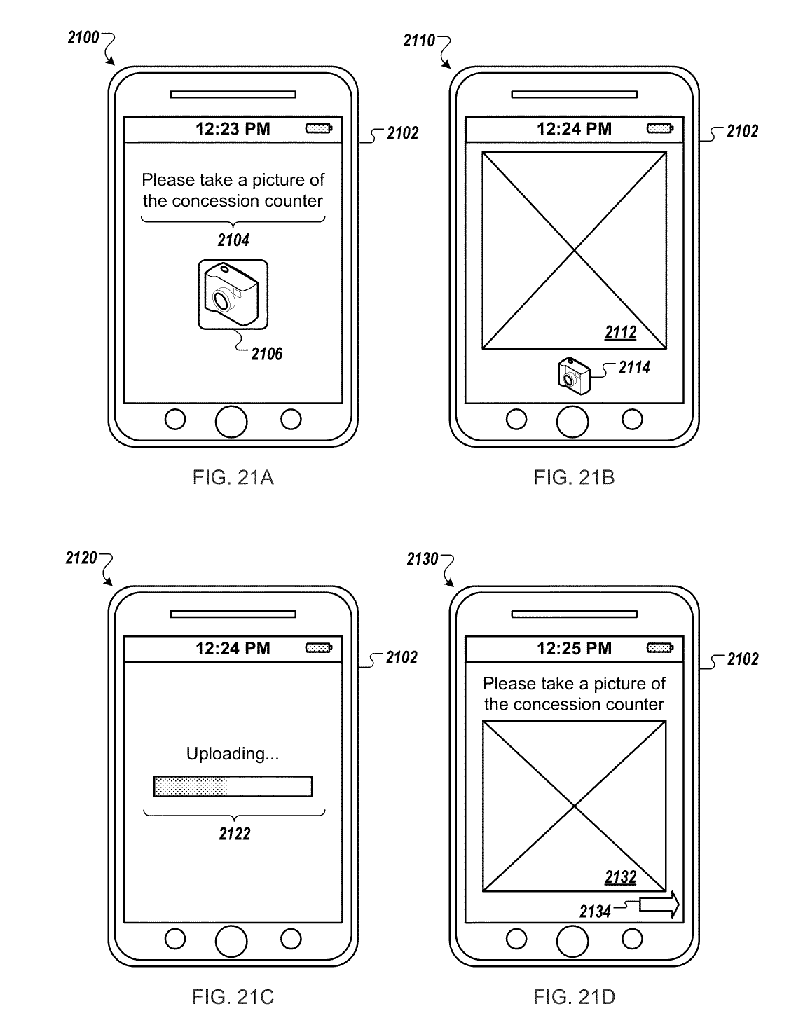

FIGS. 21A through 21D include exemplary user interfaces for answering a survey question by capturing data using a mobile computing device peripheral feature. The user interfaces, for example, may be used in implementing the capture of a rich media file as described in relation to FIG. 20. In a first user interface 2100, illustrated in FIG. 21A, a message 2104 invites the user of a mobile computing device 2102 to, “Please take a picture of the concession counter.” Beneath the message 2104, a camera icon marks a control 2106 for capturing an image, for example using a camera feature of the mobile computing device 2102. In some implementations, responsive to selection of the control 2106, a second user interface 2110 may be launched presenting an interface for capturing an image using a camera feature of the mobile computing device 2102. In some implementations, selection of the control 2106 may initiate a camera API configured to communicate instructions to a camera feature of the mobile computing device 2102.

As illustrated in FIG. 21B, in the second user interface 2102, a preview image 2112, in some implementations, may present the user with a preview of an image within the scope of a lens of a camera feature of the mobile computing device 2102. For example, the preview image 2112 may be indicative of the view presented through the viewfinder of a conventional camera. Upon selection of a snapshot control 2114, in some implementations, the user may capture an image substantially identical to the one presented within the preview image 2112. In some implementations, the user may select a separate control, such as a physical control of the mobile computing device 2102, to initiate capture of the image.

In some implementations, upon capture of the image, the image file may be automatically uploaded to a remote server, such as a server providing survey information to the mobile computing device 2102 or a media server designated by a survey application installed upon the mobile computing device 2102. As illustrated in a third user interface 2120 of FIG. 21C, a progress bar 2122, in some implementations, may provide an indication to the user regarding the portion of the image file that has been uploaded to the remote server.

Turning to FIG. 21D, in a fourth user interface 2130, in some implementations, a preview image 2132 may be presented to the user. The preview image 2132, in some implementations, may be downloaded to the mobile computing device 2102 from the remote server where the image was uploaded. For example, the preview image 2132 may provide the user the opportunity to verify that the image received by the remote server contains an adequate representation of the image captured by the user. For example, at the remote server, image data may be reformatted for storage. In resizing or altering the image data, the image content may become corrupted or reduced in quality. In another example, during upload, a file may become corrupted. In some implementations, a user may select a next control 2134 to accept the preview image 2132. Alternatively, in some implementations, the user may trigger a control, such as the capture control 2114 described in relation to FIG. 21B, to replace the captured image with a new image.

Although described in relation to image capture, other implementations, similar user interface design may be provided for the capture of audio or video files. Similarly, FIGS. 21A through 21C may be substantially similar in the construct of barcode scanning, while, rather than presenting a preview of the captured data (e.g., a preview of a barcode, QR code, etc.) in response to upload, the user may be presented with data obtained through scanning the barcode information. The information, in some examples, may include a product name, brief product description, manufacturer, lot number, and retail price.

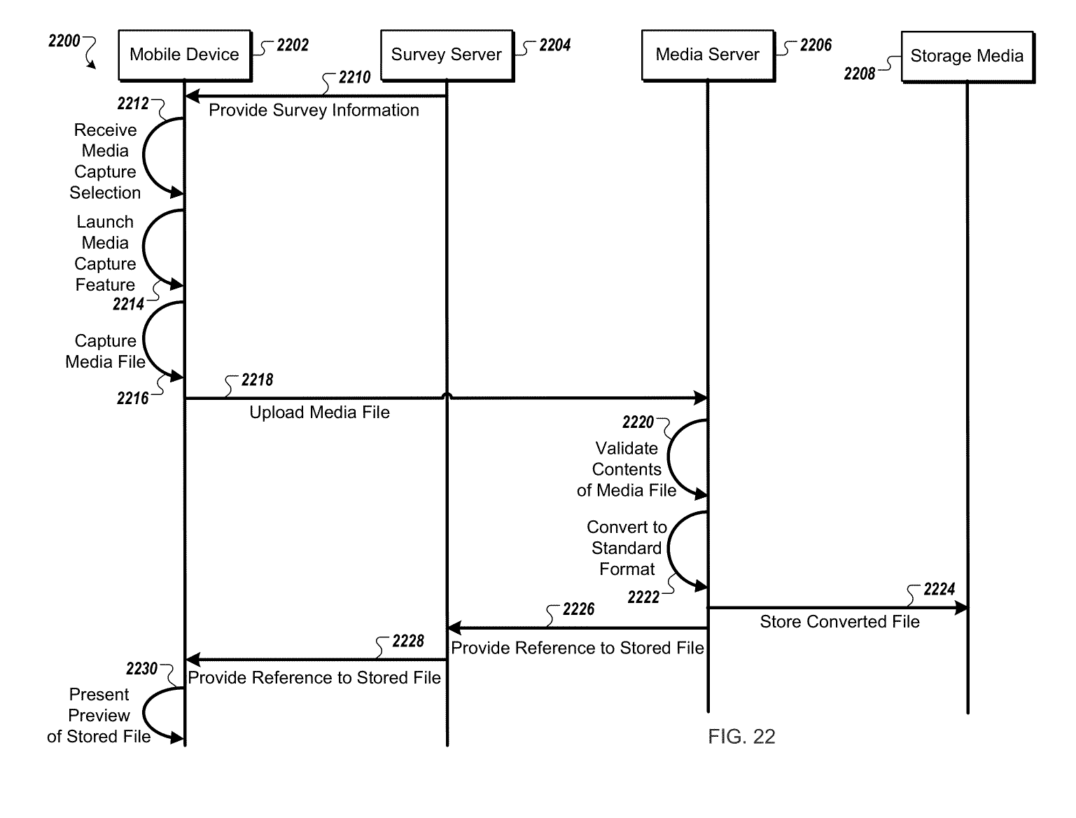

FIG. 22 is a swim diagram of an exemplary method 2200 for providing and processing survey requests including a rich media response format. The method 2200, in some implementations, may include a mobile computing device 2202 in communication with a survey server 2204 and a media server 2206. The media server 2206, in some implementations, may provide information for storage within a storage media 2208. In some implementations, the method 2200 may be executed within a system for providing and processing survey questions, such as the system 2000 described in relation to FIG. 20.

In some implementations, the method 2200 may begin with the survey server 2204 providing survey information (2210) to the mobile computing device 2202. The survey information, for example, may include a request for the user to capture data using a peripheral device feature of the mobile computing device 2202 such as, in some examples, a camera feature, a video recorder feature, and a microphone feature. In some implementations, the survey information may be received by a survey application executing upon the mobile computing device 2202.

In some implementations, the mobile computing device 2202 may receive selection of a control for capturing a rich media file (2212). In some implementations, a user of the mobile computing device 2202 may select a control icon upon a touch screen to initiate capture of a rich media file. The selection of the control for capturing the rich media file, in some implementations, may launch a rich media capture API such as, in some examples, an image capture API, a video capture API, or an audio capture API. In some implementations, the rich media capture API may be included within the survey application (e.g., downloaded and installed to the mobile computing device 2202). In some implementations, the rich media capture API may be provided by the operating system of the mobile computing device 2202.

In some implementations, a media capture feature may be launched (2214) by the mobile computing device 2202. For example, responsive to instructions provided by a rich media capture API, one or more associated media capture features may be activated. In some implementations, communications between the rich media capture API and the media capture feature may be intercepted by a survey application executing upon the mobile computing device 2202.

In some implementations, the mobile computing device 2202 may capture a rich media file (2216). The rich media file, for example, may include any rich media file type such as an image file type, video file type, or audio file type.

In some implementations, the rich media file may be uploaded (2218) to the media server 2206 by the mobile computing device 2202. In some implementations, the rich media file may be uploaded using an upload API provided by the media server 2206. The rich media file, in some implementations, may be automatically uploaded, for example upon completion of capture of the rich media file, upon completion of processing the rich media file (e.g., to reduce file size for ease of upload) or upon indication of approval by the user of the rich media file. In some implementations, additional information may be uploaded to the media server 2206 from the mobile computing device 2202. For example, the mobile computing device 2202 may provide context or meta data regarding the rich media file such as an indication of an associated survey, user information, geolocation information, mobile computing device information, and an indication of an associated survey request.

In some implementations, the media server 2206 may validate the contents of the rich media file (2220). For example, the media server 2206 may verify that the rich media file is uncorrupted or otherwise has an acceptable quality level (e.g., the image is not too dark to identify objects, the audio is not full of static, the video or audio file is of a threshold length, etc.). In some implementations, the media server 2206 may validate the contents of the rich media file in being responsive to a particular survey request. For example, the media server 2206 may verify that an image appears appropriate for the requested location (e.g., restroom, buffet table, etc.) or that it contains an appropriate object (e.g., product, logo, building, etc.). The media server 2206, in some implementations, may use language processing to identify one or more words within an audio file. For example, the media server 2206 may verify that a message contained within an audio file is likely to contain an English language response. The media server 2206, in some implementations, may identify one or more key terms within a message contained within an audio file. For example, the media server 2206 may determine that a message contained within the audio file appears to discuss a particular topic, such as a particular meal served in a restaurant, a customer service interaction, or a statement on the cleanliness of a vendor enterprise.

In some implementations, the media server 2206 may validate the rich media file in part based upon a meta data portion of the rich media file. For example, the media server 2206 may verify that the geolocation associated with the rich media file is within a threshold distance of a location associated with a survey request.

In some implementations, the media server 2206 may convert the rich media file to a standard format (2222). For example, depending upon a type or platform of mobile computing device 2202, or different capture software installed upon the mobile computing device 2202, the format of the rich media file may differ. The media server 2206, for example, may accept a number of image file formats (e.g., Joint Photographic Experts Group (JPG), Tagged Image File Format (TIFF), PDF, Graphics Interchange Format (GIF), Windows® Bitmap (BMP), etc.) and convert the file to a predetermined format (e.g., JPG). In some implementations, the media server 2206 may accept image files of varying resolution and resize or reformat the image file to a standard resolution.

In some implementations, the media server 2206 may store the converted rich media file (2224) to the storage media 2208. The storage media 2208, in some examples, may include one or more computer-readable memory devices included within the media server 2206 or accessible to the media server 2206. In some implementations, the media server 2206 may store the converted rich media file in a database, along with information associated with the capture of the rich media file. In some examples, the database may track information regarding a user of the mobile computing device 2202, a platform of the mobile computing device 2202, a geolocation of the mobile computing device 2202 at time of capture, a survey request associated with the capture of the rich media file, and a timestamp of capture of the rich media file.

The media server 2206, in some implementations, may provide a reference to the stored rich media file (2226) to the survey server 2204. The reference, in some implementations, may include a network address for accessing the stored rich media file or a preview version of the stored rich media file. For example, the reference may include a uniform resource locator (URL) or a uniform resource identifier (URI) which may be used to access a preview of the stored rich media file. The survey server 2204, in turn, may provide the reference to the stored file (2228) to the mobile computing device 2202. For example, the survey server 2204 may enable the presentation of a preview of the stored rich media file via the reference. In other implementations, the media server 2206 may provide the reference to the stored rich media file directly to the mobile computing device 2202.

In some implementations, the mobile computing device 2202 may present a preview of the stored file (2230). For example, as illustrated in relation to FIG. 21D, a preview of an image file may be presented for user review. In some implementations, the user may be provided the opportunity to approve or reject the stored rich media file. If rejected, in some implementations, the method 2200 may return to capturing a rich media file (2216).

Although illustrated in a particular series of events, in some implementations, the method 2200 may be executed with more or fewer steps, or two or more of the steps of the method 2200 may be executed in a different order. For example, although uploading of the media file (2218) is illustrated as a communication directly between the mobile computing device 2202 and the media server 2206, in some implementations, the survey server 2204 may receive the uploaded rich media file and forward a portion of the uploaded information to the media server 2206, for example for storage or for authentication processing and storage. In still other implementations, the survey server 2204 and the media server 2206 may be included within the same server or set of servers (e.g., server farm) performing a same set of operations in relation to the mobile computing device 2202.

In another example, in some implementations, the media server 2206 may not validate the contents of the media file (2220) or may share the activity of rich media file validation (2220) with the mobile computing device 2202. For example, upon capture of the rich media file, the mobile computing device 2202 (e.g., via a survey application executing thereon) may authenticate the contents of the rich media file.

In a further example, in some implementations, while validating contents of the media file (2220), the media server 2206 may determine that the contents of the media file are unacceptable. For example, the media server 2206 may determine that the timing, contents, or location related to the capture of the media file is indicative of a user attempting to receive compensation without completing the task as described by the survey (e.g., submitting answers without visiting a vendor enterprise, responding prior to interacting with staff at a vendor enterprise, submitting information that is not responsive to the request presented in the survey information, etc.). In some implementations, based upon a determination of unacceptability, the media server 2206 may alert the survey server 2204 to terminate the survey due to inappropriate behavior by the user. The media server 2206, in some implementations, may request a replacement media file of the mobile device 2202 (e.g., if the photo is too dark, audio file unclear, etc.).

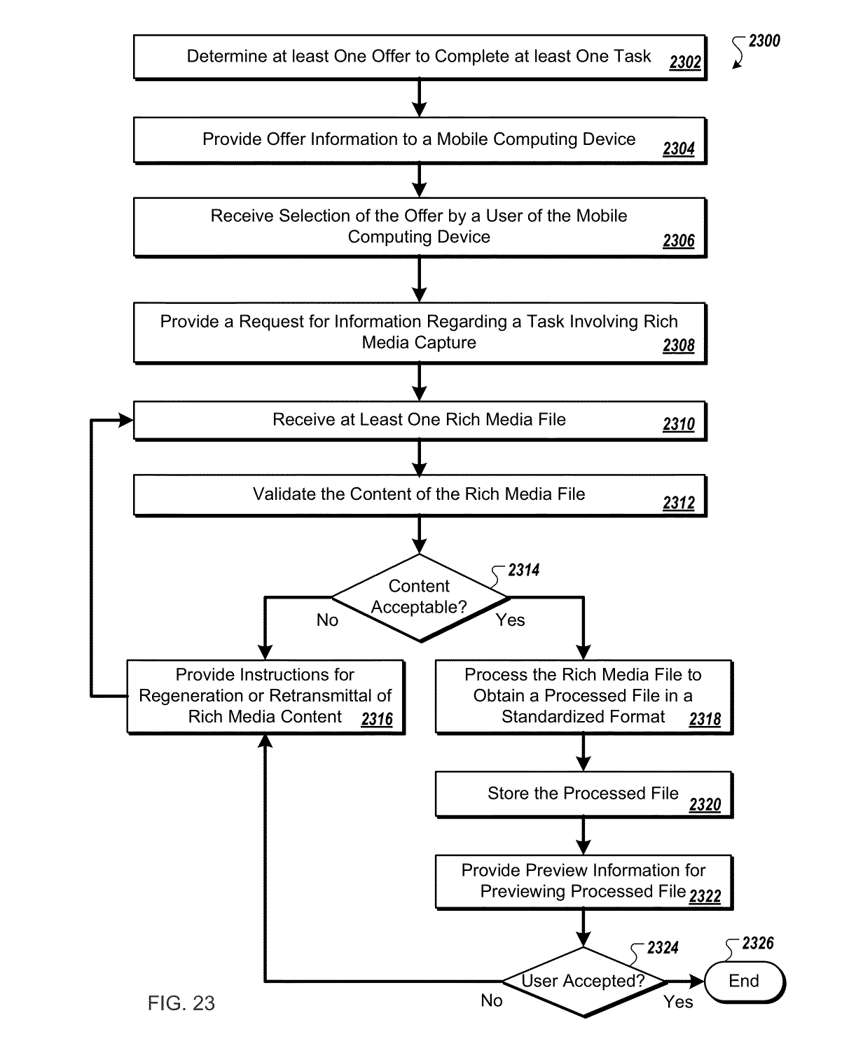

FIG. 23 is a flow diagram of an exemplary method 2300 for providing and processing survey requests including a rich media response format. The method 2300, in some implementations, may be performed by a server such as the server 2004 described in relation to FIG. 20. In some implementations, the method 2300 may be performed by two or more servers, such as a combination of the server 2004 and the media server 2008. The method 2300, in some implementations, may be performed by a survey engine such as the survey engine 2012 described in relation to FIG. 20.

In some implementations, the method 2300 may begin with determining at least one offer to complete at least one task (2302). In some implementations, the offer may include an offer for completing a survey, consumer research study, secret shopping program, or poll. The offer, in some implementations, may include a number of tasks for a user to perform prior to submitting information regarding outcome of performance of the task. In some examples, a task may involve making a purchase, visiting a building or a region of a building (e.g., the camera department of an electronics store), or asking a question of an employee. Information regarding the outcome of performance of the task, in some examples, may include selecting a multiple choice or yes/no answer, entering a text response, taking a photograph or video of an item, scanning a barcode, and/or recording an audio file including requested information. In some implementations, determining the offer may include determining a set of capabilities of a mobile computing device. For example, depending upon a type of task (e.g., image data capture, video capture, etc.) a mobile computing device executing the survey may need access to a variety of peripheral device features such as, in some examples, a camera, optical machine-readable data scanner, video recorder, or microphone. In some implementations, the method 2300 may include querying the mobile computing device to determine device information. For example, the method 2300 may query the mobile computing device to obtain a device platform, manufacturer, operating system version, peripheral device capabilities, or other information to directly or indirectly determine the features available on the mobile computing device. In some implementations, the method 2300 may access a user profile associated with a user of the mobile computing device to determine one or more features of the mobile computing device. For example, as part of registering with a survey system, a user may provide information regarding a personal mobile computing device, including, in some implementations, information regarding one or more peripheral features for capturing rich media data.

In some implementations, offer information may be provided to a mobile computing device (2304). In some implementations, the offer information may be shared with a survey application such as the survey application 2010 described in relation to FIG. 20. The offer information, in some examples, may include a name of a vendor enterprise, a location to visit to perform tasks related to the offer, mobile computing device system capabilities related to performance of tasks related to the offer (e.g., camera functionality, bar scanning functionality, etc.), an estimated length of time to perform the tasks associated with the offer, a compensation level associated with the offer, and an estimated distance between a location of the mobile computing device and the location to visit.

In some implementations, a selection of the offer by a user of the mobile computing device may be received (2306). In some implementations, a user of the mobile computing device may review offer information presented in a display area of the mobile computing device. The user may select a particular offer, for example by touching an icon associated with the offer on a touch screen, tapping on an icon associated with the offer with a stylus device, navigating to the offer using manual controls of the mobile computing device, or speaking a phrase associated with the offer to a language processing system of the mobile computing device.

In some implementations, a request for information regarding a task involving rich media capture may be provided (2308). In some implementations, the request for information may be delivered from a server via a network. The request for information, in some implementations, may have been downloaded along with the offer information. In some implementations, the request may be presented as a textual question, query, or description presented within a display area of the mobile computing device. In some implementations, the request may be presented in audio and/or video format. The request, in some implementations, may include a request for capture of a rich media file. In some examples, a rich media file may include an image file, a video file, or an audio file. For example, the request may instruct the user to take a picture of a candy display at a convenient store.

In some implementations, at least one rich media file may be received from the mobile computing device (2310). In some implementations, the rich media file may be uploaded from the mobile computing device using an upload API provided by the server receiving the rich media file. In some implementations, the rich media file may be uploaded from the mobile computing device using an upload API provided on the mobile computing device. For example, a survey application may be developed to include an upload API used to upload information to a designated media server associated with a survey provider.

In some implementations, the content of the rich media file may be validated (2312). In some implementations, the rich media file may be verified to be uncorrupted. For example, information in a header region of the file received may be checked against the contents of the rich media file to identify possible corruption. In another example, a file length may be verified against a minimum file length. The quality level of the rich media file, in some implementations, may be reviewed. For example, in the circumstance of an image file, the brightness and contrast levels may be compared to threshold levels. In another example, in the circumstance of an audio file, the audio file may be reviewed to estimate a level of static. In some implementations, the rich media file may be reviewed to determine whether it is likely to include requested content. The rich media file, in some implementations, may be associated with a particular offer or a particular task, such that threshold information and review requirements may be known. In the example of an audio file, a file length may be compared to a minimum length threshold. In the example of an image file, the image may be reviewed to determine a likelihood of the image containing a particular item or logo. In some implementations, a meta data portion of the rich media file may be reviewed to determine whether the rich media file is acceptable. For example, geocoordinates within the meta data may be compared to a location associated with the task.

In some implementations, if the content is determined to be unacceptable (2314), instructions for regeneration or re-transmittal of rich media content may be provided (2316). For example, should the file be deemed corrupted or of improper quality level, information may be presented to the user informing the user to replace the unacceptable rich media file. The information, for example, may be presented in a display area of the mobile computing device. In another example, audible instructions may be played to a user, instructing the user to perform an additional capture of a rich media file. In some implementations, a programming instruction may be provided to an application to re-send a corrupted file or a file that failed to fully transfer. In some implementations, a user may be provided with information regarding compensation for providing replacement content. For example, compensation for completion of a particular offer may be dependent upon satisfying a threshold quality level in responses provided to the survey system. In some examples, a user may be required to complete a threshold number of tasks, where responses to each of the threshold number of tasks may be determined to be sufficiently responsive by the system prior to authorizing compensation in relation to completion of the offer tasks.

Responsive to request for regeneration or re-transmittal, in some implementations, at least one rich media file may be received (2310). For example, the user may capture a replacement rich media file, or the survey application on the mobile computing device may attempt automatic retransmission of a corrupted file.

If, instead, the content is determined to be acceptable (2314), in some implementations, the rich media file may be processed to obtain a processed file in a standardized format (2318). In some implementations, the rich media file may be processed to convert the file to a particular file format. For example, in the circumstance of an image file, irrespective of the original file format, the file may be converted to the JPG format. The rich media file, in some implementations, may be adjusted to a particular size or a particular level of richness of data. In some examples, a file may be compressed, reduced in complexity, or reduced in depth of information.

In some implementations, the processed file may be stored (2320). In some implementations, the rich media file may be received and stored in a temporary location, such as a cache memory. In some implementations, for longer term storage (e.g., hours, days, weeks, months, years, etc.), the processed version of the rich media file may be stored within a data repository.

In some implementations, preview information for previewing the processed file may be provided (2322). In some implementations, the preview information may include a network address where a version of the processed rich media file is accessible. In some examples, a URL or URI to the processed rich media file or a truncated (e.g., thumbnail) version of the processed rich media file may be provided to the mobile computing device. In some implementations, a thumbnail, truncated, or preview version of the processed rich media file may be provided to the mobile computing device.

In some implementations, the user may be provided the opportunity to accept the processed file (2324). For example, the user may review the preview of the processed rich media file to determine that it adequately conveys the information the user had intended to capture in response to a task or a request presented in relation to the offer. If the user determines that the processed file is unacceptable (2324), in some implementations, instructions may be provided for regeneration or re-transmittal of the rich media content (2316). For example, the user may determine that capturing a new rich media file may be beneficial in providing an accurate and complete response to a task or request. For example, compensation for completion of a particular offer may be dependent upon satisfying a threshold quality level in responses provided to the survey system. In some examples, a user may be required to complete a threshold number of tasks, where responses to each of the threshold number of tasks may be determined to be sufficiently responsive by the system prior to authorizing compensation in relation to completion of the offer tasks. In some implementations, compensation may be dependent upon review post-completion of the offer. For example, validation of responses may occur, in part, at the conclusion of a survey. User compensation, in some implementations, may depend in part upon the validation post-processing. To be positioned to compensation, or to receive a higher compensation level, a user may be prompted to provide as complete and accurate a response as possible.

If, instead, the user determines that the processed file is acceptable (2324), the process 2300 may end (2326).

Although described in relation to a particular series of steps, in some implementations, the method 2300 may include more or fewer steps. For example, in some implementations, the method 2300 may neglect to provide preview information for previewing the processed file (2322). In another example, in some implementations, upon storing the processed file (2320), information regarding the user, the offer, the task, a timestamp, a geolocation, or other data or meta data may be associated with the processed file, for example within a database system. In some implementations, one or more of the steps of the method 2300 may be arranged in a different order. For example, one or more of the steps described in relation to determining acceptability of the rich media file (2314) may be executed after processing the rich media file to obtain a processed rich media file in a standardized format (2318). Other modifications of the method 2300 are possible without deviating from the concepts and scope of the method 2300.

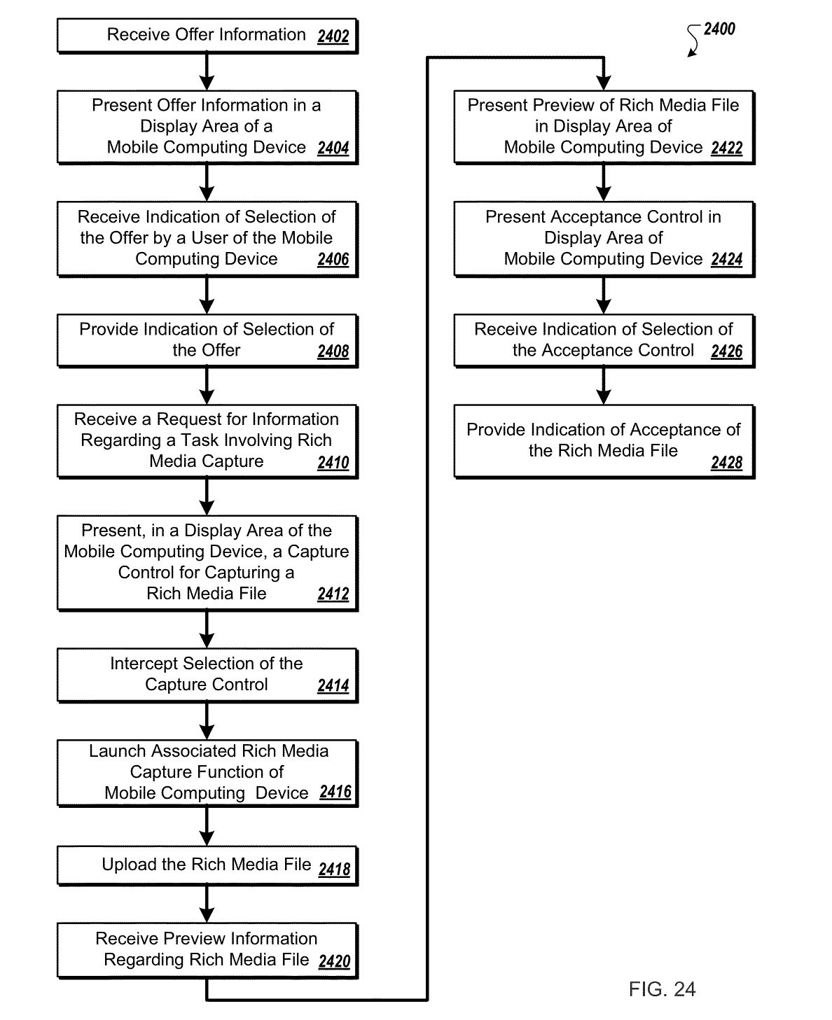

FIG. 24 is a flow diagram of an exemplary method 2400 for receiving and responding to survey requests including a rich media response format. The method 2400, in some implementations, may be performed by a mobile computing device such as the mobile computing device 2002 described in relation to FIG. 20.

In some implementations, the method 2400 may begin with receiving offer information (2402). The offer information, in some implementations, may be received from a server via a network, such as the server 2004 described in relation to FIG. 20. In some implementations, the offer information may be received by a survey application, such as the survey application 2010 described in relation to FIG. 20. In some implementations, the offer may include an offer for completing a survey, consumer research study, secret shopping program, or poll. The offer, in some implementations, may include a number of tasks for a user to perform prior to submitting information regarding outcome of performance of the task. In some examples, a task may involve making a purchase, visiting a building or a region of a building (e.g., the camera department of an electronics store), or asking a question of an employee. Information regarding the outcome of performance of the task, in some examples, may include selecting a multiple choice or yes/no answer, entering a text response, taking a photograph or video of an item, scanning a barcode, and/or recording an audio file including requested information. The offer information, in some examples, may include a name of a vendor enterprise, a location to visit to perform tasks related to the offer, mobile computing device system capabilities related to performance of tasks related to the offer (e.g., camera functionality, bar scanning functionality, etc.), an estimated length of time to perform the tasks associated with the offer, a compensation level associated with the offer, and an estimated distance between a location of the mobile computing device and the location to visit.

In some implementations, offer information may be presented in a display area of a mobile computing device (2404). In some implementations, a brief description or overview of one or more offers may be listed within a browser interface or an application interface rendered in the display area. Each offer within the offer information, in some implementations, may be selectable by the user, for example using an input mechanism of the mobile computing device.

In some implementations, an indication of selection of the offer by a user of the mobile computing device may be received (2406). For example, via an input mechanism of the mobile computing device, a user may provide selection of a particular offer. In some implementations, one or more offers within a list of offers may not be available for selection by the user until geocoordinates of the mobile computing device enter within a threshold distance of a location associated with the offer. For example, a user may have to be within a quarter mile of a vendor enterprise prior to a particular offer being activated within the display area of the mobile computing device. In some implementations, a survey application executing upon the mobile computing device may monitor current location of the mobile computing device. The mobile computing device, in some implementations, may provide periodic updates regarding the geolocation of the mobile computing device to a remote server (e.g., across the network). The server, in response, may initiate activation of one or more offers depending upon the current estimated location of the mobile computing device in relation to locations associated with each of the one or more offers.

In some implementations, an indication of selection of the offer may be provided to a remote computing system (2408). In some implementations, the mobile computing device may provide information indicating the offer to a survey engine functioning upon a remote server accessible via a network.

In some implementations, a request for information regarding a task involving rich media capture may be received (2410). In some implementations, the request for information may be delivered from a server via a network. The request for information, in some implementations, may have been downloaded along with the offer information. In some implementations, the request may be presented as a textual question, query, or description presented within a display area of the mobile computing device. In some implementations, the request may be presented in audio and/or video format. The request, in some implementations, may include a request for capture of a rich media file. In some examples, a rich media file may include an image file, a video file, or an audio file. For example, the request may instruct the user to record a response an employee provides to a particular question the user has been instructed to ask of the employee. In some implementations, the request may include compensation information and/or acceptance criteria indicative of a threshold responsiveness or an example of acceptable response. For example, compensation provided to a user may be dependent in part upon validation of responses to requests from the server. In some implementations, response data relating to individual tasks may be correlated with acceptance criteria (e.g., an audio file may be correlated with a minimum length, an image file correlated with a level of clarity, etc.).

In some implementations, a capture control for capturing a rich media file may be presented in a display area of the mobile computing device (2412). In some implementations, the capture control may be similar to the control 2104 presented within the user interface 2100 described in relation to FIG. 21A. The capture control, in some implementations, may, upon selection, launch a rich media capture feature of the mobile computing device, such as the rich media capture features 2014a, 2014b, and 2014c described in relation to FIG. 20. In some implementations, the capture control may provide commands to a rich media capture feature of the mobile computing device via an API, such as the capture APIs 2016 described in relation to FIG. 20.

In some implementations, user selection of the capture control may be intercepted (2414). In some implementations, a survey application executing upon the mobile computing device may intercept user selection of the capture control and redirect the commands via a rich media capture API associated with the survey application.

In some implementations, a rich media capture function of the mobile computing device associated with the capture control may be launched (2416). In some implementations, interception of the capture control may provide a survey application the ability to launch a rich media capture interface within the user interface of the survey application. For example, as illustrated in the user interface 2110 of FIG. 21B, the image capture interface may be presented within the survey application.

In some implementations, a rich media file may be uploaded via a network (2418). In some implementations, the rich media file may be automatically uploaded upon completion of capture. For example, a survey application may call an upload API of a media server associated with the survey engine, such as the upload APIs 2018 described in relation to FIG. 20. An upload API provided in the survey application, in some implementations, may be coded with address information regarding a network destination for the rich media file. In some implementations, the user may be alerted that the rich media file is being uploaded. For example, within a display area of the mobile computing device, an uploading message may be presented to the user, such as the progress bar 2122 within the user interface 2120 described in relation to FIG. 21C.

In some implementations, preview information regarding the rich media file may be received (2420). In some implementations, the preview information may include a network address where a version of the processed rich media file is accessible. In some examples, a URL or URI to the processed rich media file or a truncated (e.g., thumbnail) version of the processed rich media file may be provided to the mobile computing device. In some implementations, a thumbnail, truncated, or preview version of the processed rich media file may be provided to the mobile computing device.

In some implementations, a preview of the rich media file may be presented in a display area of the mobile computing device (2422). The survey application, in some implementations, may present the preview or a control for launching a preview, within a display area of the mobile computing device. For example, a preview image such as the preview image 2132 described in relation to the user interface 2130 of FIG. 21D may be presented to the user.

In some implementations, an acceptance control may be presented in a display area of the mobile computing device (2424). The acceptance control, in some implementations, may provide the user with the option of approving of the final response provided in relation to the request or task. For example, the user may review the preview of the processed rich media file to determine that it adequately conveys the information the user had intended to capture in response to a task or a request presented in relation to the offer. The acceptance control, in some implementations, may include a selectable graphical control provided within a display area of the mobile computing device. In some implementations, verbal approval of the rich media file preview may be requested (e.g., using a language processing feature of the mobile computing device).

In some implementations, an indication of selection of the acceptance control may be received (2426). For example, a user may provide selection of the acceptance control via an input mechanism of the mobile computing device.

In some implementations, an indication of acceptance of the rich media file may be provided via the network (2428). In some implementations, the mobile computing device may provide information indicating acceptance of the rich media file to a survey engine functioning upon a remote server accessible via a network.

Although described in relation to a particular series of steps, in some implementations, the method 2400 may include more or fewer steps. For example, in some implementations, preview information regarding the rich media file may not be received (2420). In some implementations, one or more of the steps of the method 2400 may be arranged in a different order. For example, in some implementations, prior to upload of the rich media file (2418), the contents of the rich media file may be verified. The quality level of the rich media file, in some implementations, may be reviewed. For example, in the circumstance of an image file, the brightness and contrast levels may be compared to threshold levels. In another example, in the circumstance of an audio file, the audio file may be reviewed to estimate a level of static. In some implementations, the rich media file may be reviewed to determine whether it is likely to include requested content. The rich media file, in some implementations, may be associated with a particular offer or a particular task, such that threshold information and review requirements may be known. In the example of an audio file, a file length may be compared to a minimum length threshold. In some implementations, language processing may be used to identify one or more words within an audio file. For example, it may be verified that a message contained within an audio file is likely to contain an English language response. In some implementations, one or more key terms may be identified within a message contained within an audio file. For example, it may be determined that a message contained within the audio file appears to discuss a particular topic, such as a particular meal served in a restaurant, a customer service interaction, or a statement on the cleanliness of a vendor enterprise. In the example of an image file, in some implementations, the image may be reviewed to determine a likelihood of the image containing a particular item or logo. In some implementations, content of a rich media file may be reviewed to determine that it does not include inappropriate material (e.g., nudity in a photo, foul language in an audio recording, etc.).

In some implementations, a meta data portion of the rich media file may be reviewed to determine whether the rich media file is acceptable. For example, geocoordinates within a meta data portion of the rich media file may be compared to a location associated with the task. A timestamp within the meta data portion of the rich media file, in some implementations, may be examined to determine if a threshold amount of time has passed for the response to be considered valid relative to a request. For example, a response regarding the completion of a meal may not be considered valid if provided seven minutes after a response relating to placing an order.

In some implementations, responsive to acceptance of the rich media file (2428), the method 2400 may authorize compensation to the user. For example, a compensation level associated with the offer may depend upon validation of responses to each of the one or more tasks to be performed in relation to the offer. Depending upon verification and validation of user responses, for example, differing levels of compensation may be awarded. In some implementations, an offer may be terminated prematurely based upon determination of improper responses by a user. For example, based upon a determination that a user is attempting to receive compensation without properly performing the requested tasks, the method 2400 may terminate an ongoing survey.

Other modifications of the method 2400 are possible without deviating from the concepts and scope of the method 2400.

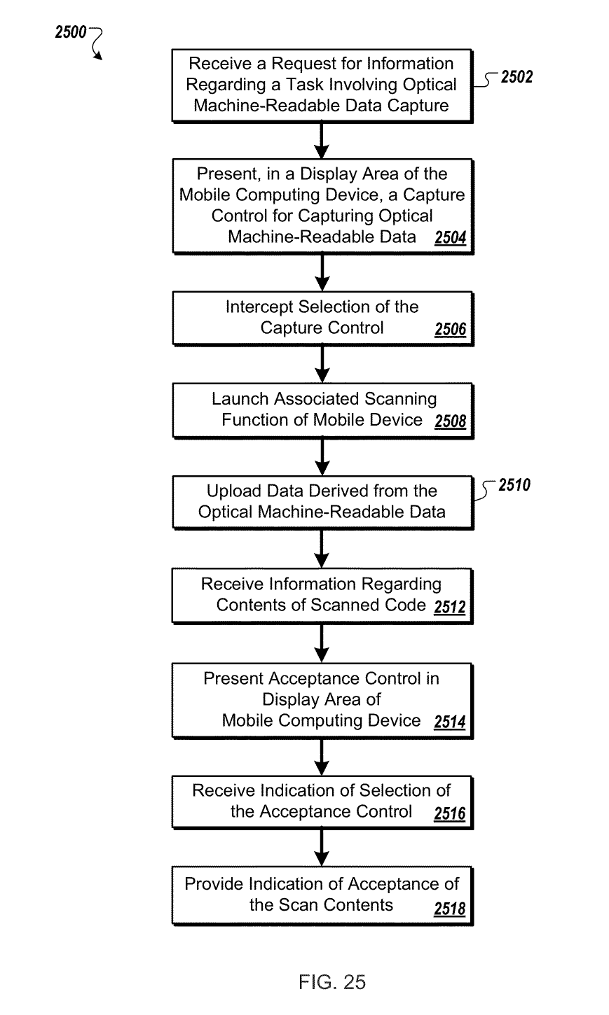

FIG. 25 is a flow diagram of an exemplary method 2500 for receiving and responding to survey requests including an optical machine-readable data response format. The method 2500, in some implementations, may be performed by a mobile computing device such as the mobile computing device 2002 described in relation to FIG. 20. For example, as described in relation to FIG. 20, a survey application such as the survey application 2010 may perform at least a portion of the method 2500. Activities leading up to the beginning of the method 2500, in some implementations, may be similar to the actions 2402 through 2406 described in relation to FIG. 24. For example, the method 2500 may be invoked in response to a user accepting an offer for a survey, consumer research program, secret shopping program, or poll, including a task for capturing optical machine-readable data.

In some implementations, the method 2500 may begin with receiving a request for information regarding a task involving optical machine-readable data capture (2502). In some implementations, the request for information may be delivered from a server via a network. The request for information, in some implementations, may have been downloaded along with offer information regarding an offer for performing a survey, consumer research program, secret shopping program, or poll. In some implementations, the request may be presented as a textual question, query, or description presented within a display area of a mobile computing device. In some implementations, the request may be presented in audio and/or video format. The request, in some implementations, may include a request for capture of optical machine-readable data capture such as, in some examples, a barcode, matrix barcode, 2D barcode, QR code, and color barcode. For example, the request may instruct the user to scan the barcode of one or more items the user has purchased at a pharmacy (e.g., allergy medicine, tissues, eye drops, etc.).

In some implementations, a capture control for capturing optical machine-readable data may be presented in a display area of a mobile computing device (2504). In some implementations, the capture control may be similar to the control 2104 presented within the user interface 2100 described in relation to FIG. 21A. The capture control, in some implementations, may, upon selection, launch an optical machine-readable data scanning feature of the mobile computing device, such as the barcode scanning feature 2014d described in relation to FIG. 20. In some implementations, the capture control may provide commands to a barcode scanning feature of the mobile computing device via an API, such as the optical scanning API 2016d described in relation to FIG. 20.

In some implementations, selection of the capture control may be intercepted (2506). In some implementations, a survey application executing upon the mobile computing device may intercept user selection of the capture control and redirect the commands via an optical machine-readable data capture API associated with the survey application.

In some implementations, a scanning function associated with the capture control may be launched (2508). In some implementations, interception of the capture control may provide a survey application the ability to launch an optical machine-readable data capture interface within the user interface of the survey application. For example, similar to the image capture interface illustrated in the user interface 2110 of FIG. 21B, an optical machine-readable data capture interface may be presented within the survey application.

In some implementations, scan data derived from scanning optical machine-readable data via the scanning function may be uploaded via the network (2510). In some implementations, only a portion of the scan data may be uploaded. For example, a survey application may select portions of interest such as, in some examples, a product name and a product identification number, from a complete set of scan data (e.g., discarding information such as lot number, expiration date, etc.). In some implementations, all of the retrieve data may be uploaded, or a product identification number may be uploaded. For example, in some implementations, only a product identification number may be recognized via the scan, and a remote server may associate the product identification number with product information.

In some implementations, the information derived through scanning the optical machine-readable data may be automatically uploaded upon completion of capture. For example, a survey application may call an API of a server associated with the survey engine, such as the upload APIs 2018 described in relation to FIG. 20. An API provided in the survey application, in some implementations, may be coded with address information regarding a network destination for the scan data. In some implementations, the user may be alerted that the scan data is being uploaded. For example, within a display area of the mobile computing device, an uploading message may be presented to the user, such as the progress bar 2122 illustrated within the user interface 2120 of FIG. 21C.

In some implementations, scan information regarding the contents of the optically scanned machine-readable data may be received (2512). For example, in the case that a product identification number was provided to a remote server, and the remote server derived information regarding the product, scan information may include a product name, product size, representative product image, etc.

In some implementations, an acceptance control may be presented in a display area of the mobile computing device (2514). The acceptance control, in some implementations, may provide the user with the option of approving of the final response provided in relation to the request or task. For example, the user may preview information derived from scanning the optical machine-readable data to determine that it adequately conveys the information the user had intended to capture in response to a task or a request presented in relation to the offer (e.g., a product name matching the product name listed on the packaging, etc.). The acceptance control, in some implementations, may include a selectable graphical control provided within a display area of the mobile computing device. In some implementations, verbal approval of the preview information may be requested (e.g., using a language processing feature of the mobile computing device).

In some implementations, an indication of selection of the acceptance control may be received (2516). For example, via an input mechanism of the mobile computing device, a user may provide selection of the acceptance control.

In some implementations, indication of acceptance of the scan contents may be provided via the network (2518). In some implementations, the mobile computing device may provide information indicating the approval of the preview information to a survey engine functioning upon a remote server accessible via a network.

Although described in relation to a particular series of steps, in some implementations, the method 2500 may include more or fewer steps. For example, upon receiving information regarding contents of the scanned code (2512), the method 2500, in some implementations, may compare a product identification code to a set of valid product identification codes provided by a vendor enterprise to validate the captured information. In some implementations, in another example, the media server 2206 may verify that a product identification code relates to a particular type of product in a set of valid product types. For example, in relation to personal care, valid product types may include shampoo, conditioner, bar soap, body wash, and shaving cream. In some implementations, one or more of the steps of the method 2500 may be arranged in a different order. Other modifications of the method 2500 are possible without deviating from the concepts and scope of the method 2500.

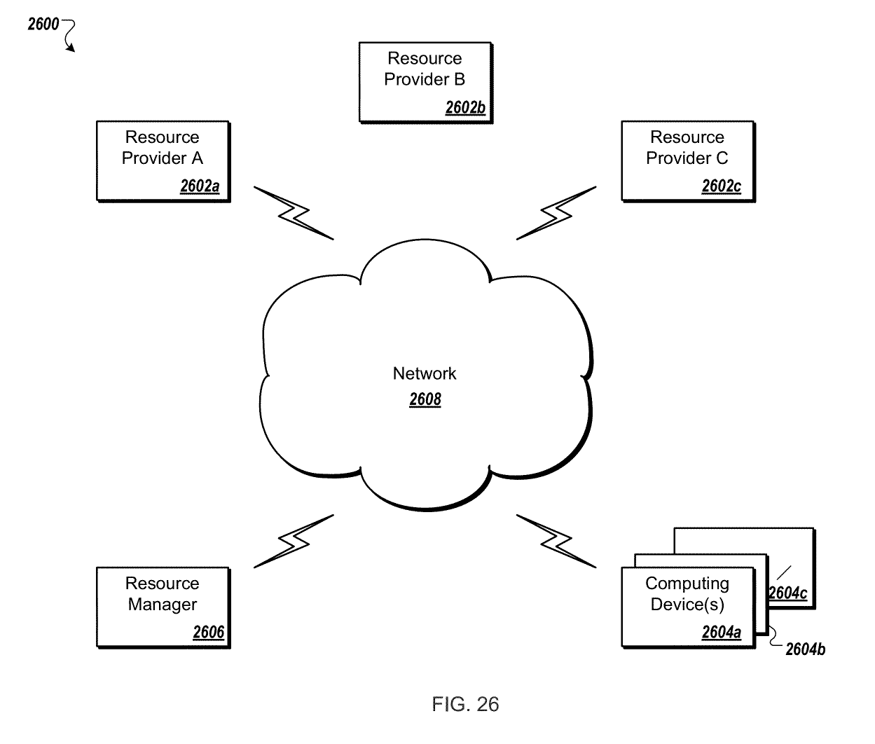

As shown in FIG. 26, an implementation of a network environment 2600 for selecting and processing offers to complete tasks is shown and described. In brief overview, referring now to FIG. 26, a block diagram of an exemplary cloud computing environment 2600 is shown and described. The cloud computing environment 2600 may include one or more resource providers 2602a, 2602b, 2602c (collectively, 2602). Each resource provider 2602 may include computing resources. In some implementations, computing resources may include any hardware and/or software used to process data. For example, computing resources may include hardware and/or software capable of executing algorithms, computer programs, and/or computer applications. In some implementations, exemplary computing resources may include application servers and/or databases with storage and retrieval capabilities. Each resource provider 2602 may be connected to any other resource provider 2602 in the cloud computing environment 2600. In some implementations, the resource providers 2602 may be connected over a computer network 2608. Each resource provider 2602 may be connected to one or more computing device 2604a, 2604b, 2604c (collectively, 2604), over the computer network 2608.

The cloud computing environment 2600 may include a resource manager 2606. The resource manager 2606 may be connected to the resource providers 2602 and the computing devices 2604 over the computer network 2608. In some implementations, the resource manager 2606 may facilitate the provision of computing resources by one or more resource providers 2602 to one or more computing devices 2604. The resource manager 2606 may receive a request for a computing resource from a particular computing device 2604. The resource manager 2606 may identify one or more resource providers 2602 capable of providing the computing resource requested by the computing device 2604. The resource manager 2606 may select a resource provider 2602 to provide the computing resource. The resource manager 2606 may facilitate a connection between the resource provider 2602 and a particular computing device 2604. In some implementations, the resource manager 2606 may establish a connection between a particular resource provider 2602 and a particular computing device 2604. In some implementations, the resource manager 2606 may redirect a particular computing device 2604 to a particular resource provider 2602 with the requested computing resource.

While various implementations of the methods and systems have been described, these implementations are exemplary and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the exemplary implementations and should be defined in accordance with the accompany claims and their equivalents.

What is claimed is:

1. A method comprising:
receiving, at a mobile computing device from a server via a network, survey information, wherein the survey information comprises data capture instructions;
presenting, by a processor of the mobile computing device, on a display of the mobile computing device, the data capture instructions and a control for capturing data, wherein
the control for capturing data is configured upon selection to activate a peripheral feature of the mobile computing device, and
wherein the peripheral feature is configured to capture one or more of audio content, image content, and video content;
receiving selection of the control for capturing data;
activating, by the processor, the peripheral feature;
intercepting, by the processor, capture data, wherein the capture data was created by the peripheral feature; and
providing, to the server via the network, capture information associated with the capture data.

2. The method of claim 1, wherein the capture information comprises a rich media file.

3. The method of claim 1, further comprising:
receiving, from the server, responsive to the capture information, verification information; and
presenting, by the processor, on the display, the verification information and a control, wherein the control is configured upon selection to cause an indication of approval to be provided to the server.

4. The method of claim 3, wherein the verification information comprises a network address for reviewing a portion of the capture information.

5. The method of claim 4, wherein:
the peripheral feature comprises a camera, wherein the peripheral feature is configured to capture image content;
the capture information comprises an image file; and
the portion of the capture information comprises a scaled version of the image file.

6. The method of claim 1, wherein:
the peripheral feature comprises an optical scanner, wherein the peripheral feature is configured to capture image content; and
the portion of the capture information comprises meta data regarding a product.

7. The method of claim 1, wherein providing the capture information comprises providing a command to an upload interface of the server.

8. The method of claim 1, wherein the server comprises two or more networked servers.

9. The method of claim 1, wherein presenting the data capture instructions comprises presenting the data capture instructions within a browser application executing upon the mobile computing device.

10. The method of claim 1, further comprising
receiving, from the server, responsive to the capture information, rejection information, wherein the rejection information is provided responsive to a determination that the capture information is insufficient; and
responsive to receiving the rejection information, causing presentation, by the processor, on the display, data recapture instructions and the control for capturing data.

11. An apparatus comprising:
a non-transitory memory having instructions thereon that, when executed by a processor, cause the processor to:
receive, at a mobile computing device from a server via a network, survey information, wherein the survey information comprises data capture instructions;
present, on a display of the mobile computing device, the data capture instructions and a control for capturing data, wherein
the control for capturing data is configured upon selection to activate a peripheral feature of the mobile computing device, and
wherein the peripheral feature is configured to capture one or more of audio content, image content, and video content;
receive selection of the control for capturing data;
activate the peripheral feature;
intercept capture data, wherein the capture data was created by the peripheral feature; and
provide, to the server via the network, capture information associated with the capture data.

12. A method comprising:
determining, by a processor of a computing device, an offer comprising at least one task;
providing, for presentation on a mobile computing device, offer information, wherein the offer information comprises identification of the offer;
receiving, from the mobile computing device, a selection identifying the offer;
determining, by the processor that the mobile computing device comprises a peripheral feature configured to capture a rich media file type, wherein a first task of the at least one task comprises capturing the rich media file type;
providing, for presentation on the mobile computing device, a request for information related to the first offer, wherein the request comprises a request for a user to perform the first task;
receiving, from the mobile computing device, information related to an outcome of performance of the first task, wherein:
the information related to the outcome of performance of the first task comprises capture information derived from capture of the rich media file type, and
the information related to the outcome of performance of the task is indicative of a completion of the task by the user;
determining, by the processor, acceptability of the capture information; and
providing, by the processor, to the mobile computing device, preview information configured to present a preview version of a portion of the capture information to the user.

13. The method of claim 12, wherein determining the offer comprises determining the offer responsive to determining that the mobile computing device comprises the peripheral feature configured to capture the rich media file type.

14. The method of claim 12, wherein determining acceptability of the capture information comprises validating content of the capture information in relation to the first task.

15. The method of claim 14, wherein:
the first task comprises a location;
the capture information comprises geolocation information; and
validating content of the capture information comprises determining the geolocation information is within a threshold distance of the location.

16. The method of claim 14, wherein:
the first task comprises recording an audio message;
the capture information comprises an audio file; and
validating content of the capture information comprises determining the audio file meets a threshold recording length.

17. The method of claim 14, wherein:
the first task comprises scanning a bar code;
the capture information comprises a product identification code; and
validating content of the capture information comprises determining one or more predetermined product identification codes comprises the product identification code.

18. The method of claim 12, further comprising storing, by the processor, the capture information in a memory.

19. The method of claim 18, further comprising, prior to storing the capture information:
modifying, by the processor, the capture information, wherein
the capture information is modified to a standardized file format.

20. The method of claim 12, further comprising:
receiving, from the mobile computing device, an indication of rejection of the preview information; and
responsive to the indication of rejection, providing, to the mobile computing device, recapture information.
